(19) United States
(12) Patent Application Publication
(10) Pub. No.: US 2017/0052709 A1
(43) Pub. Date: Feb. 23, 2017

(54) STORAGE SYSTEM, STORAGE CONTROL APPARATUS, AND STORAGE CONTROL METHOD

(71) Applicant: FUJITSU LIMITED, Kawasaki-shi (JP)

(72) Inventors: Masato Kawamura, Machida (JP); Hidekazu KAWANO, Saitama (JP)

(73) Assignee: FUJITSU LIMITED, Kawasaki-shi (JP)

(21) Appl. No.: 15/234,346

(22) Filed: Aug. 11, 2016

(30) Foreign Application Priority Data
Aug. 21, 2015 (JP) 2015-163781

(51) Int. Cl. G06F 3/06; G06F 13/16; G06F 12/1009

(52) U.S. Cl. CPC G06F 3/065; G06F 12/1009; G06F 3/0619; G06F 3/0647; G06F 3/0664; G06F 3/0683; G06F 13/1668; G06F 2212/1032

(57) ABSTRACT

A storage system includes first and second apparatuses and a management apparatus. The first apparatus includes first storage and a first processor. The first processor notifies the common apparatus information and the common area information to a superordinate apparatus through a first path. Upon receiving a request to access the virtual area from the superordinate apparatus through the first path, the first processor performs the access on basis of first management information associating the virtual area with a first area. The second apparatus includes second storage and a second processor. The second processor notifies the common apparatus information and the common area information to the superordinate apparatus through a second path. Upon receiving a request to access the virtual area from the superordinate apparatus through the second path, the second processor performs the access on basis of second management information associating the virtual area with a second area.

### CROSS-REFERENCE TO RELATED APPLICATION

This application is based upon and claims the benefit of priority of the prior Japanese Patent Application No. 2015-163781, filed on Aug. 21, 2015, the entire contents of which are incorporated herein by reference.

### FIELD

The embodiments discussed herein are related to a storage system, a storage control apparatus, and a storage control method.

### BACKGROUND

A storage apparatus has been widely used in which a plurality of hard disk drives (HDD) or solid state drives (SSD) are configured to be redundant using the a redundant array of inexpensive disk (RAID) technology or the like, and thus data reliability is improved and a large capacity is realized. In addition, a method has been also used of preparing a pair of storage apparatuses, synchronizing the data of a logical unit (LU), which is managed by one storage apparatus, with an LU, which is managed by the other storage apparatus, thereby reducing risk in which data is lost due to failures occurred in the LUs.

In addition, a storage system has been proposed which generates one virtual volume by virtualizing a plurality of LUs, which are managed by a plurality of storage apparatuses, sets a logical unit number (LUN) to the virtual volume, and notifies the LUN to a host computer. The host computer does not directly recognize the plurality of LUs, in which the virtual volume is set, and inputs and outputs data to and from the virtual volume on the basis of the notified LUN.

The plurality of LUs, in which the virtual volume is set, form a remote copy pair of LUs, one LU of the pair is managed as a primary volume, and the other LU of the pair is managed as a secondary volume into which data written in the primary volume is copied. In the storage system, it is possible to input and output the data using the secondary volume, into which the same data as in the primary volume is copied, even in a case where failures occur in the primary volume.

In addition, a storage system has been proposed which, in a case where the amount of access to the primary volume exceeds a threshold, selects a secondary volume that has higher input and output performance than the primary volume, copies the data of the primary volume into the selected secondary volume, and replaces the primary volume with the secondary volume.

Meanwhile, a multi-path control technology has been proposed in which the host computer is connected to the storage apparatus through a plurality of communication paths (host paths) and load conditions of a control mechanism and the LUs in the storage apparatuses are monitored for the respective host paths, thereby adjusting the amount of access requests for the respective host paths. The host computer receives notifications of the pieces of identification information (apparatus IDs) of the storage apparatuses and the LUNs from the respective host paths, and performs multi-path control using the notified apparatus IDs and the LUNs.

Related techniques are disclosed in, for example, Japanese National Publication of International Patent Application No. 2012-504793, Japanese Laid-open Patent Publication No. 2011-76286, and Japanese Laid-open Patent Publication No. 2011-192269.

In a case where one storage apparatus, which manages the primary volume, receives a request to perform writing to the primary volume from the host computer, the storage apparatus transmits data to the other storage apparatus after writing the data to the primary volume. The other storage apparatus writes the transmitted data in the secondary volume. Therefore, identical data is stored in the primary volume and the secondary volume, thereby causing a state in which data is duplexed.

During the storage apparatus, which manages the primary volume, normally operates, the host computer inputs and outputs data to and from the storage apparatus. Accordingly, as long as the input and output to and from the primary volume are normally performed, the data which is copied into the secondary volume and the host path which is related to the storage apparatus which manages the secondary volume are not availably utilized. If it is possible to use the data copied to the secondary volume and availably utilize an input and output mechanism that includes the host path for the storage apparatus which manages the secondary volume, it is possible to expect the improvement of access performance.

### SUMMARY

According to an aspect of the present invention, provided is a storage system including a first storage control apparatus, a second storage control apparatus, and a management apparatus. The first storage control apparatus includes a first storage device and a first processor. The first storage device is configured to store therein first management information in which common apparatus information, common area information, and first area information are associated with each other. The common apparatus information identifies a virtual storage control apparatus. The common area information identifies a virtual storage area. The first area information identifies a first storage area. The first processor is configured to notify the common apparatus information and the common area information to a superordinate apparatus through a first path. The first processor is configured to receive a request for a first access to access the virtual storage area from the superordinate apparatus through the first path. The first processor is configured to perform the first access on basis of the first management information. The second storage control apparatus includes a second storage device and a second processor. The second storage device is configured to store therein second management information in which the common apparatus information, the common area information, and second area information are associated with each other. The second area information identifies a second storage area. The second processor is configured to notify the common apparatus information and the common area information to the superordinate apparatus through a second path. The second processor is configured to receive a request for a second access to access the virtual storage area from the superordinate apparatus through the second path. The second processor is configured to perform the second access on basis of the second management information. The management apparatus includes a third processor. The third processor is configured to allocate the common apparatus information to the first storage control apparatus and the second storage control apparatus. The third processor is configured to allocate the common area information to the first storage area and the second storage area. The third processor is configured to notify the common apparatus information and the common area information to the first storage control apparatus and the second storage control apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a storage system according to a first embodiment;

FIG. 2 is a diagram illustrating an example of a storage system according to a second embodiment;

FIG. 3 is a diagram illustrating an example of hardware of a server apparatus according to the second embodiment;

FIG. 4 is a diagram illustrating an example of functions of the server apparatus and a storage control apparatus according to the second embodiment;

FIG. 5 is a diagram illustrating an example of a virtual environment table (copy source) according to the second embodiment;

FIG. 6 is a diagram illustrating an example of the virtual environment table (copy destination) according to the second embodiment;

FIG. 7 is a diagram illustrating an example of a function of a management apparatus according to the second embodiment;

FIG. 8 is a diagram illustrating an example of state monitoring information according to the second embodiment;

FIG. 9 is a diagram illustrating an example of a virtual LU-ID management table according to the second embodiment;

FIG. 10 is a diagram illustrating relationships between combinations of an LU state of a copy source and an LU state of a copy destination and a state of the system;

FIG. 11 is a diagram illustrating an example of an operation (at “equivalent state”) of the storage control apparatus according to the second embodiment;

FIG. 12 is a diagram illustrating an example of an operation (at “abnormal volume”) of the storage control apparatus according to the second embodiment;

FIG. 13 is a diagram illustrating an example of an operation (at “in the middle of copying”) of the storage control apparatus according to the second embodiment;

FIG. 14 is a diagram illustrating an example of an operation (at “copy suspension”) of the storage control apparatus according to the second embodiment;

FIG. 15 is a sequence diagram illustrating a flow of a virtualization setting process according to the second embodiment;

FIG. 16 is a flowchart illustrating a flow of an equivalence process according to the second embodiment;

FIG. 17 is a first flowchart illustrating a flow of a process in response to a host request according to the second embodiment;

FIG. 18 is a second flowchart illustrating a flow of a process in response to the host request according to the second embodiment;

FIG. 19 is a third flowchart illustrating a flow of a process in response to the host request according to the second embodiment;

FIG. 20 is a fourth flowchart illustrating a flow of a process in response to the host request according to the second embodiment;

FIG. 21 is a flowchart illustrating a flow of a process in response to a counter party request according to the second embodiment;

FIG. 22 is a sequence diagram illustrating a flow of a process performed in a case where abnormalities occur in a copy path and the copy path is restored according to the second embodiment;

FIG. 23 is a first flowchart illustrating a flow of a process of selecting an apparatus to be used according to the second embodiment;

FIG. 24 is a second flowchart illustrating a flow of a process of selecting the apparatus to be used according to the second embodiment;

FIG. 25 is a diagram illustrating an example of a storage system according to a third embodiment;

FIG. 26 is a diagram illustrating an example of a virtual environment table (copy source) according to the third embodiment;

FIG. 27 is a diagram illustrating an example of the virtual environment table (copy destination) according to the third embodiment;

FIG. 28 is a diagram illustrating an example of a virtual LU-ID management table according to the third embodiment;

FIG. 29 is a diagram illustrating an example of an operation of a storage control apparatus and an example of transition of the virtual LU-ID management table according to the third embodiment;

FIG. 30 is a first flowchart illustrating a flow of a process of selecting an apparatus to be used according to the third embodiment; and

FIG. 31 is a second flowchart illustrating a flow of a process of selecting the apparatus to be used according to the third embodiment.

### DESCRIPTION OF EMBODIMENTS

Hereinafter, embodiments will be described with reference to the accompanying drawings. In the specification and drawings, the same reference numerals are attached to components, which have substantially the same function, and thus there is a case in which the description thereof is not repeated.

### First Embodiment

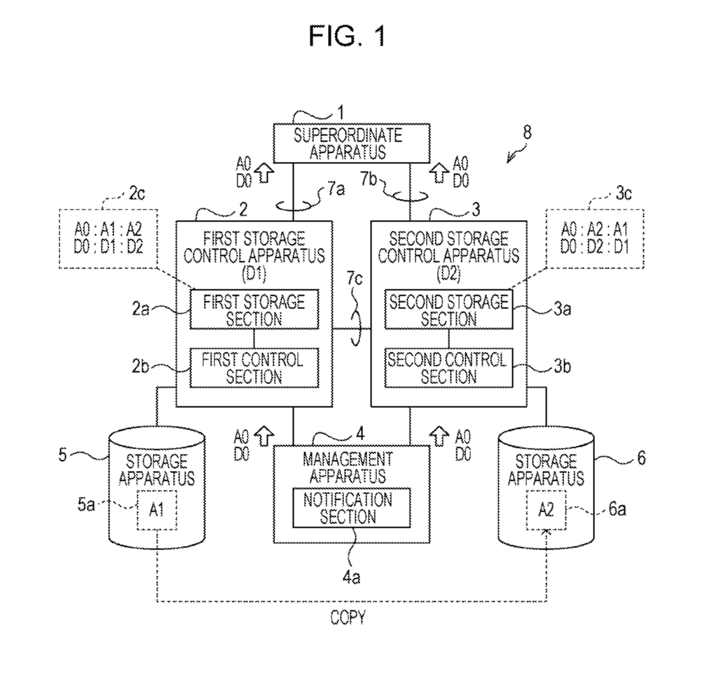

A first embodiment will be described with reference to FIG. 1. FIG. 1 is a diagram illustrating an example of a storage system according to the first embodiment. The storage system 8 illustrated in FIG. 1 is an example of the storage system according to the first embodiment.

As illustrated in FIG. 1, the storage system 8 includes a first storage control apparatus 2 and a second storage control apparatus 3, which are connected to a superordinate apparatus 1, and a management apparatus 4 which manages the first storage control apparatus 2 and the second storage control apparatus 3. The management apparatus 4 is connected to the first storage control apparatus 2 and the second storage control apparatus 3. The storage system 8 includes a storage apparatus 5 which is connected to the first storage control apparatus 2, and a storage apparatus 6 which is connected to the second storage control apparatus 3.

The superordinate apparatus 1 is a server apparatus which functions as a host computer. The first storage control apparatus 2 is connected to the superordinate apparatus 1 through a first path 7a. The second storage control apparatus 3 is connected to the superordinate apparatus 1 through a second path 7b. In addition, the second storage control apparatus 3 is connected to the first storage control apparatus 2 through a third path 7c. Hereinafter, there is a case in which the first path 7a and the second path 7b are referred to as host paths. In addition, there is a case in which the third path 7c is referred to as a copy path.

For example, the first storage control apparatus 2 is connected to the superordinate apparatus 1 through a storage area network (SAN) using a fibre channel (FC). In addition, the second storage control apparatus 3 is connected to the superordinate apparatus 1 through SAN using FC. In addition, the first storage control apparatus 2 is connected to the second storage control apparatus 3 using, for example, FC, an internet small computer system interface (iSCSI), and the like.

The first storage control apparatus 2 and the second storage control apparatus 3 may be connected to the superordinate apparatus 1 through an FC switch (FC fabric). It is possible to use, for example, connection methods using a local area network (LAN) or a wide area network (WAN) in addition to the connection method using FC. Hereinafter, for convenience of explanation, a connection method using FC is assumed for the host paths and a connection method using the iSCSI is assumed for the copy path.

In the superordinate apparatus 1, a plurality of host bus adapters (HBA) are provided as FC interfaces. In the first storage control apparatus 2 and the second storage control apparatus 3, a channel adapter (CA) and a remote adapter (RA) are provided as the FC interface and the iSCSI interface, respectively.

A communication path, which connects an HBA of the superordinate apparatus 1 to the CA of the first storage control apparatus 2, forms the first path 7a. A communication path, which connects an HBA of the superordinate apparatus 1 to the CA of the second storage control apparatus 3, forms the second path 7b. A communication path, which connects the RA of the first storage control apparatus 2 to the RA of the second storage control apparatus 3, forms the third path 7c.

In FIG. 1, the first path 7a is expressed by one line. However, the number of lines of the first path 7a may be two or more. Similarly, the number of lines of the second path 7b may be two or more and the number of lines of the third path 7c may be two or more. It is possible to recognize the first path 7a and the second path 7b using, for example, identification information such as the World Wide Name (WWN) which is allocated to each CA and each HBA. It is possible to recognize the third path 7c using identification information such as an iSCSI Qualified Name (IQN).

The storage apparatuses 5 and 6 include an HDD, an SSD, or the like. The storage apparatuses 5 and 6 may be a RAID apparatus which is acquired by combining a plurality of HDDs or SSDs in a redundant manner. Logical storage areas (LUs) are allocated to physical storage areas (physical volumes) of the storage apparatuses 5 and 6. In the example of FIG. 1, a first storage area 5a, which is identified by first area information A1, is allocated to a physical volume of the storage apparatus 5. In addition, a second storage area 6a, which is identified by second area information A2, is allocated to a physical volume of the storage apparatus 6. The LUN is an example of the area information.

The first storage area 5a is an LU which is managed by the first storage control apparatus 2. The second storage area 6a is an LU which is managed by the second storage control apparatus 3 and into which the data of the first storage area 5a is copied through the third path 7c. For example, in a case where data is written in the first storage area 5a, the data is transferred to the second storage control apparatus 3 through the third path 7c and is written in the second storage area 6a. That is, the data of the first storage area 5a and the data of the second storage area 6a are synchronized.

As illustrated in FIG. 1, the first storage control apparatus 2 includes a first storage section 2a and a first control section 2b. The second storage control apparatus 3 includes a second storage section 3a and a second control section 3b. The management apparatus 4 includes a notification section 4a.

It is possible to realize the functions of the first storage section 2a and the second storage section 3a using a storage apparatus such as a random access memory (RAM), an HDD, and a flash memory. It is possible to realize the functions of the first control section 2b, the second control section 3b, and the notification section 4a using a processor such as a central processing unit (CPU) and an electronic circuit such as a field programmable gate array (FPGA). The first control section 2b, the second control section 3b, and the notification section 4a perform processes on the basis of, for example, a program which is stored in a memory (not shown in the drawing).

The notification section 4a sets common area information A0 for identifying a common virtual storage area which is associated with the first storage area 5a and the second storage area 6a, and notifies the set common area information A0 to the first storage control apparatus 2 and the second storage control apparatus 3.

In addition, the notification section 4a sets common apparatus information D0 for identifying a common virtual storage control apparatus which is associated with the first storage control apparatus 2 and the second storage control apparatus 3. The notification section 4a notifies the set common apparatus information D0 to the first storage control apparatus 2 and the second storage control apparatus 3.

First management information 2c is stored in the first storage section 2a. The first management information 2c includes information in which the common area information A0 is associated with the first area information A1 for identifying the first storage area 5a. In addition, the first management information 2c includes information in which the common apparatus information D0 is associated with the first apparatus information D1 for identifying the first storage control apparatus 2.

In the first management information 2c illustrated in FIG. 1, the common area information A0 is associated with the first area information A1 (A0:A1). Meanwhile, in the specification, the symbol “:” indicates a correspondence relationship. In addition, in the first management information 2c, the common apparatus information D0 is associated with the first apparatus information D1 (D0:D1).

As illustrated in FIG. 1, the first management information 2c may include information (A0:A1:A2) in which area information (the second area information A2 in the example) of an LU, to which the same common area information A0 is set, is further associated with the common area information A0. In addition, the first management information 2c may include information (D0:D1:D2) in which apparatus information (the second apparatus information D2 in the example) of a storage control apparatus, to which the same common apparatus information D0 is set, is further associated with the common apparatus information D0.

The first control section 2b notifies the common apparatus information D0 and the common area information A0 to the superordinate apparatus 1 through the first path 7a.

For example, in a case where the first control section 2b enables (linking-up) the first path 7a, the first control section 2b notifies the common apparatus information D0 to the superordinate apparatus 1 through the first path 7a. With the notification, the superordinate apparatus 1 recognizes that the first path 7a is a host path of a storage control apparatus which is identified by the common apparatus information D0. In addition, with the notification of the common area information A0 through the first path 7a, the superordinate apparatus 1 recognizes the LU, which is identified by the common area information A0, as an LU which may be accessed through the first path 7a.

The superordinate apparatus 1 manages the host path, the apparatus information, and the area information in association with each other, and accesses the storage area on the basis of the apparatus information and the area information. The common area information A0 is area information which identifies virtual LUs which are allocated to the first storage area 5a and the second storage area 6a. However, the superordinate apparatus 1 issues an access request without distinguishing whether a target, which is indicated by the area information, is an LU (actual LU) that is actually allocated to a physical volume or a virtual LU that is associated with the actual LU and virtualizes the actual LU.

The first control section 2b performs an access to the virtual LU, which is requested from the superordinate apparatus 1 through the first path 7a, on the basis of the first management information 2c. For example, the first control section 2b refers to the first management information 2c, and performs a process by replacing an access request to a storage area, which is designated by the common apparatus information D0 and the common area information A0, with an access request to the first storage area 5a which is designated by the first apparatus information D1 and the first area information A1.

In a case where the first management information 2c includes information in which the common area information A0 is associated with the second area information A2 and the common apparatus information D0 is associated with the second apparatus information D2, the first control section 2b may perform the process by replacing with an access request to the second storage area 6a. For example, in a case where abnormalities occur in the first storage area 5a or time is taken for accessing the first storage area 5a (in a case where loads are high), the first control section 2b may perform the process by replacing with an access request to the second storage area 6a.

Second management information 3c is stored in the second storage section 3a. The second management information 3c includes information in which the common area information A0 is associated with the second area information A2 for identifying the second storage area 6a. In addition, the second management information 3c includes information in which the common apparatus information D0 is associated with the second apparatus information D2 for identifying the second storage control apparatus 3.

In the second management information 3c illustrated in FIG. 1, the common area information A0 is associated with the second area information A2 (A0:A2). In addition, in the second management information 3c, the common apparatus information D0 is associated with the second apparatus information D2 (D0:D2).

As illustrated in FIG. 1, the second management information 3c may include information (A0:A2:A1) in which area information (the first area information A1 in the example) of an LU, to which the same common area information A0 is set, is further associated with the common area information A0. In addition, the second management information 3c may include information (D0:D2:D1) in which apparatus information (the first apparatus information D1 in the example) of a storage control apparatus, to which the same common apparatus information D0 is set, is further associated with the common apparatus information D0.

The second control section 3b notifies the common apparatus information D0 and the common area information A0 to the superordinate apparatus 1 through the second path 7b.

For example, in a case where the second control section 3b enables (linking-up) the second path 7b, the second control section 3b notifies the common apparatus information D0 to the superordinate apparatus 1 through the second path 7b. With the notification, the superordinate apparatus 1 recognizes that the second path 7b is a host path of a storage control apparatus which is identified by the common apparatus information D0. In addition, with the notification of the common area information A0 through the second path 7b, the superordinate apparatus 1 recognizes the LU, which is identified by the common area information A0, as an LU which may be accessed through the second path 7b.

The second control section 3b performs an access to a virtual LU, which is requested from the superordinate apparatus 1 through the second path 7b, on the basis of the second management information 3c. For example, the second control section 3b refers to the second management information 3c, and performs a process by replacing an access request to a storage area, which is designated by the common apparatus information D0 and the common area information A0, with an access request to the second storage area 6a which is designated by the second apparatus information D2 and the second area information A2.

In a case where the second management information 3c includes information in which the common area information A0 is associated with the first area information A1 and the common apparatus information D0 is associated with the first apparatus information D1, the second control section 3b may perform the process by replacing with an access request to the first storage area 5a. For example, in a case where abnormalities occur in the second storage area 6a or time is taken for accessing the second storage area 6a (in a case where loads are high), the second control section 3b may perform the process by replacing with an access request to the first storage area 5a.

As described above, since the common apparatus information D0 is notified to the superordinate apparatus 1 from both the first path 7a and the second path 7b, the superordinate apparatus 1 recognizes the existence of the storage control apparatuses which are connected through the first path 7a and the second path 7b. Furthermore, since the common area information A0 is notified to the superordinate apparatus 1 from both the first path 7a and the second path 7b, the superordinate apparatus 1 recognizes that the recognized storage control apparatuses manage the LU which is identified by the common area information A0.

The storage control apparatus, which is identified by the common apparatus information D0, is a virtual storage control apparatus. In addition, the LU, which is identified by the common area information A0, is a virtual LU. However, the superordinate apparatus 1 performs an access control in the same manner as in a case of accessing one LU included in one storage control apparatus, using a plurality of host paths without recognizing whether or not the LU is a virtual LU. For example, the superordinate apparatus 1 controls the amount of access requests for each host path such that loads are equally dispersed to each host path.

The data, which is written in the first storage area 5a, is also written in the second storage area 6a through the third path 7c. That is, in a case of a write access, a write process is performed on both the first storage area 5a and the second storage area 6a even in a case where the access request is dispersedly issued in the first path 7a and the second path 7b. Therefore, it is possible to expect the dispersion of the communication loads on the host paths and the dispersion of the loads on the HBAs and the CAs which form the interfaces of the host paths.

In a case of a read access, since identical data is stored in the first storage area 5a and the second storage area 6a, it is possible to independently read data from the first storage area 5a and the second storage area 6a, respectively. Therefore, it is possible to expect the increase in a response speed due to parallel read processes in addition to the dispersion of the communication loads on the host paths and the dispersion of the loads on the HBAs and the CAs which form the interfaces of the host paths.

In the method of the first embodiment, a virtual storage control apparatus and a virtual LU are expressed as an actual storage control apparatus and an actual LU to the superordinate apparatus 1. Therefore, it is possible to apply the method of the first embodiment regardless a multi-path control method which is employed by the superordinate apparatus 1, and thus it is possible to acquire load dispersion effect by an arbitrary multi-path control which is embedded in the superordinate apparatus 1. In addition, from the fact that the embodiment is not dependent on the multi-path control method, the degree of freedom of system design is high, and thus it is possible to expect to reduce design cost.

Hereinabove, the first embodiment has been described. The number of superordinate apparatuses 1 may be two or more. In this case, the management apparatus 4 sets the common apparatus information and the common area information for each superordinate apparatus 1, and the first storage control apparatus 2 and the second storage control apparatus 3 notify the common apparatus information and the common area information to the superordinate apparatuses 1 through each host path.

### Second Embodiment

Subsequently, a second embodiment will be described. The second embodiment provides a technology which improves read access performance by virtualizing the storage apparatuses and the LUs for a storage system in which a remote copy function for synchronizing the data of LUs between the storage apparatuses is provided.

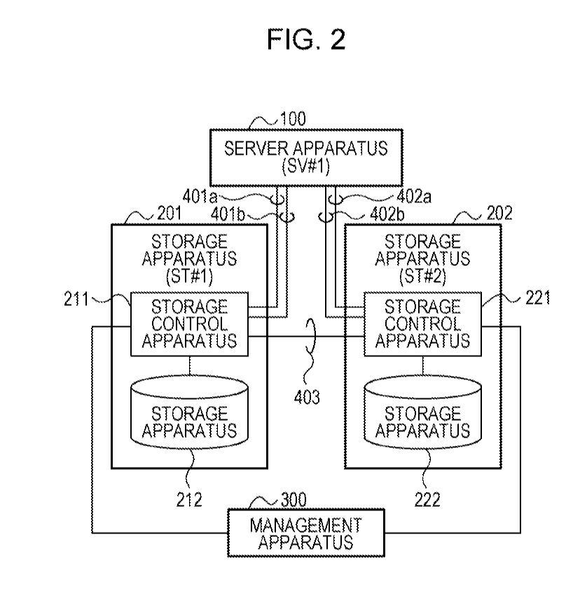

A storage system according to the second embodiment will be described with reference to FIG. 2. FIG. 2 is a diagram illustrating an example of the storage system according to the second embodiment.

As illustrated in FIG. 2, the storage system according to the second embodiment includes storage apparatuses 201 and 202, which are connected to a server apparatus 100, and a management apparatus 300 which manages the storage apparatuses 201 and 202. The server apparatus 100 functions as a host computer. Hereinafter, for convenience of explanation, there is a case in which the server apparatus 100 is expressed as SV#1, the storage apparatus 201 is expressed as ST#1, and the storage apparatus 202 is expressed as ST#2.

The storage apparatus 201 includes a storage control apparatus 211 and a storage apparatus 212.

The storage control apparatus 211 controls read/write of data for the storage apparatus 212. For example, the storage control apparatus 211 writes data to the storage apparatus 212 in accordance with a write request which is received from the server apparatus 100, and returns a response indicative of completion of the writing to the server apparatus 100. In addition, the storage control apparatus 211 reads the data from the storage apparatus 212 in accordance with a read request which is received from the server apparatus 100 and responds to the server apparatus 100 using the read data.

The storage apparatus 202 includes a storage control apparatus 221 and a storage apparatus 222.

The storage control apparatus 221 controls read/write of data for the storage apparatus 222. For example, the storage control apparatus 221 writes data in the storage apparatus 222 in accordance with a write request which is received from the server apparatus 100, and returns a response indicative of completion of the writing to the server apparatus 100. In addition, the storage control apparatus 221 reads the data from the storage apparatus 222 in accordance with a read request which is received from the server apparatus 100 and responds to the server apparatus 100 using the read data.

The storage apparatuses 212 and 222 include an HDD, an SSD, or the like. The storage apparatuses 212 and 222 may be a RAID apparatus which is acquired by combining a plurality of HDDs or SSDs in a redundant manner. LUs are allocated to the physical volumes of the storage apparatuses 212 and 222.

The storage control apparatus 211 is connected to the server apparatus 100 through paths 401a and 401b. The storage control apparatus 221 is connected to the server apparatus 100 through paths 402a and 402b. In addition, the storage control apparatus 221 is connected to the storage control apparatus 211 through a path 403. Hereinafter, there is a case in which the paths 401a, 401b, 402a, and 402b are referred to as host paths. In addition, there is a case in which the path 403 is referred to as a copy path.

For example, the storage control apparatus 211 is connected to the server apparatus 100 through SAN using FC. The storage control apparatus 221 is connected to the server apparatus 100 through SAN using FC. The storage control apparatus 211 and the storage control apparatus 221 are each connected to the server apparatus 100 through an FC switch (not shown in the drawing). The storage control apparatus 211 is connected to the storage control apparatus 221 through the iSCSI. The management apparatus 300 is connected to the storage control apparatuses 211 and 221 using, for example, LAN or the like.

A plurality of HBAs, which are FC interfaces, are provided in the server apparatus 100. In addition, a plurality of CAs which are FC interfaces and an RA which is an iSCSI interface are provided in each of the storage control apparatus 211 and the storage control apparatus 221.

Communication paths, which connect the HBAs of the server apparatus 100 to the CAs of the storage control apparatus 211, form the paths 401a and 401b. Communication paths, which connect the HBAs of the server apparatus 100 to the CAs of the storage control apparatus 221, form the paths 402a and 402b. A communication path, which connects the RA of the storage control apparatus 211 to the RA of the storage control apparatus 221, forms the path 403.

It is possible to identify the paths 401a, 401b, 402a, and 402b using, for example, identification information such as a WWN that is allocated to each of the CAs and each of the HBAs. It is possible to identify the path 403 using identification information such as an IQN.

In a case where data is written in an LU which is allocated to the physical volume of the storage apparatus 212 in accordance with a write request, the storage control apparatus 211 writes the data in the LU and transfers the data to the storage control apparatus 221 through the path 403. The storage control apparatus 221 writes the data, which is transferred through the path 403, in an LU which is allocated to the physical volume of the storage apparatus 222.

As described above, the storage control apparatuses 211 and 221 have a remote copy function for synchronizing the data of the set LUs. Hereinafter, for convenience of explanation, it is assumed that the storage control apparatus 211 is set as the copy source of synchronization copy and the storage control apparatus 221 is set as the copy destination of the synchronization copy in a normal state. However, it is possible to replace the copy source with the copy destination depending on the operational states of the storage control apparatuses 211 and 221 and the states of the paths 401a, 401b, 402a, 402b, and 403.

The management apparatus 300 monitors the states of the storage control apparatuses 211 and 221, the storage apparatuses 212 and 222, and the paths 401a, 401b, 402a, 402b, and 403, and controls the operations of the storage control apparatuses 211 and 221 depending on the monitored states. In addition, the management apparatus 300 performs setting and control relevant to the virtualization of the LUs and the storage control apparatuses 211 and 221.

Hereinabove, the storage system has been described.

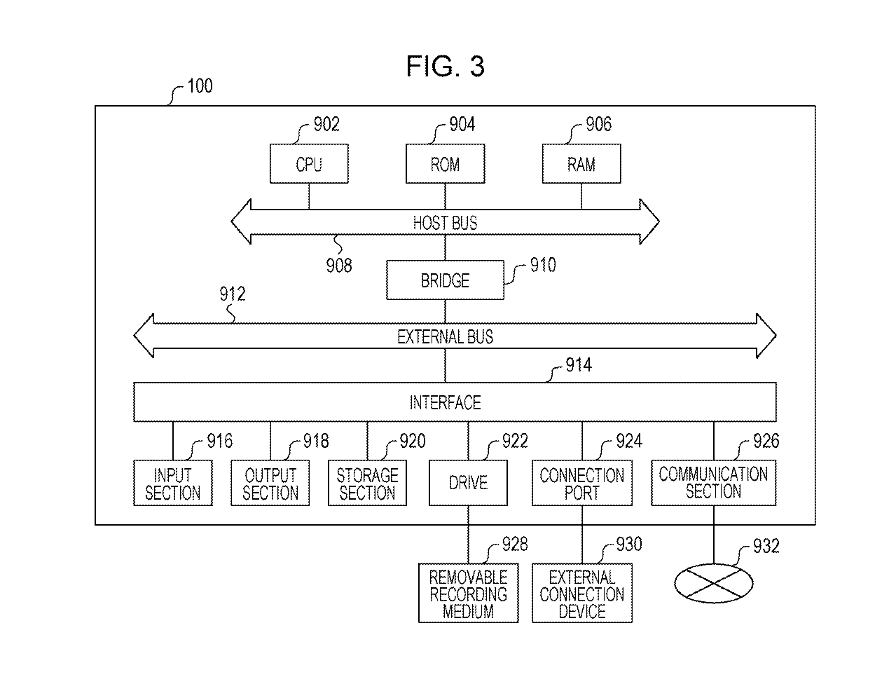

Subsequently, hardware of the server apparatus 100 will be described with reference to FIG. 3. FIG. 3 is a diagram illustrating an example of the hardware of the server apparatus according to the second embodiment.

It is possible to realize the functions of the server apparatus 100 using, for example, hardware resources of an information processing apparatus illustrated in FIG. 3. That is, the functions of the server apparatus 100 are realized by controlling the hardware illustrated in FIG. 3 in accordance with a computer program.

As illustrated in FIG. 3, the hardware mainly includes a CPU 902, a read-only memory (ROM) 904, a RAM 906, a host bus 908, and a bridge 910. Furthermore, the hardware includes an external bus 912, an interface 914, an input section 916, an output section 918, a storage section 920, a drive 922, a connection port 924, and a communication section 926.

The CPU 902 functions as, for example, an arithmetic processing apparatus or a control apparatus, and controls the entire or a part of operation of each of the configuration components on the basis of various programs which are recorded in the ROM 904, the RAM 906, the storage section 920, or a removable recording medium 928. The ROM 904 is an example of a storage apparatus for storing a program which is read and executed by the CPU 902 or data which is used for an operation. In the RAM 906, for example, a program which is read and executed by the CPU 902, various parameters which change in a case where the program is executed, and the like are temporarily or permanently stored.

These components are connected to each other through, for example, the host bus 908 which is capable of performing high-speed data transmission. The host bus 908 is connected to the external bus 912 having a relatively low data transmission rate through, for example, a bridge 910. A mouse, a keyboard, a touch panel, a touch pad, buttons, switches, a lever, or the like is used as the input section 916, for example. There is a case in which a remote controller that may transmit a control signal using infrared rays or other radio waves is used as the input section 916.

A display apparatus, such as a cathode ray tube (CRT), a liquid crystal display (LCD), a plasma display panel (PDP), or an electro-luminescence display (ELD), is used as the output section 918, for example. There is a case in which an audio output apparatus such as a speaker or a headset, a printer, or the like is used as the output section 918. That is, the output section 918 is an apparatus which may visually or audibly output information.

The storage section 920 is an apparatus for storing various data. A magnetic storage device, such as an HDD, is used as the storage section 920, for example. A semiconductor storage device, such as an SSD or a RAM disk, an optical storage device, a magneto-optical storage device, or the like may be used as the storage section 920.

The drive 922 is an apparatus for reading information which is recorded in the removable recording medium 928 that is a detachable recording medium or writing the information in the removable recording medium 928. A magnetic disk, an optical disk, a magneto-optical disk, a semiconductor memory, or the like may be used as the removable recording medium 928, for example.

The connection port 924 is a port for connecting, for example, an external connection device 930 and includes an universal serial bus (USB) port, an IEEE1394 port, a small computer system interface (SCSI), an RS-232C port, and an optical audio terminal. A printer or the like is used as the external connection device 930, for example. The HBA is an example of the connection port 924.

The communication section 926 is a communication device for connecting to the network 932. For example, A communication circuit for a wired or wireless LAN, a communication circuit for a wireless USB (WUSB), a communication circuit or a router for optical communication, a communication circuit or a router for an asymmetric digital subscriber line (ADSL), a communication circuit for a mobile telephone network, or the like is used as the communication section 926, for example. The network 932, which is connected to the communication section 926, is a network which is connected in a wired or wireless manner, and includes, for example, the Internet, a LAN, a broadcast network, a satellite communication line, and the like.

Although it is possible to realize the functions of the server apparatus 100 using the hardware illustrated in FIG. 3, it is possible to omit a part of components of the above-described hardware depending on the application form of the server apparatus 100, and it is possible to add other components.

It is also possible to realize the functions of the storage control apparatuses 211 and 221 using the hardware, such as the CPU 902, the RAM 906, and the storage section 920, of the hardware illustrated in FIG. 3. In this case, the CAs and the RAs are examples of the connection port 924. It is also possible to realize the functions of the management apparatus 300 using the hardware illustrated in FIG. 3.

Hereinabove, the hardware has been described.

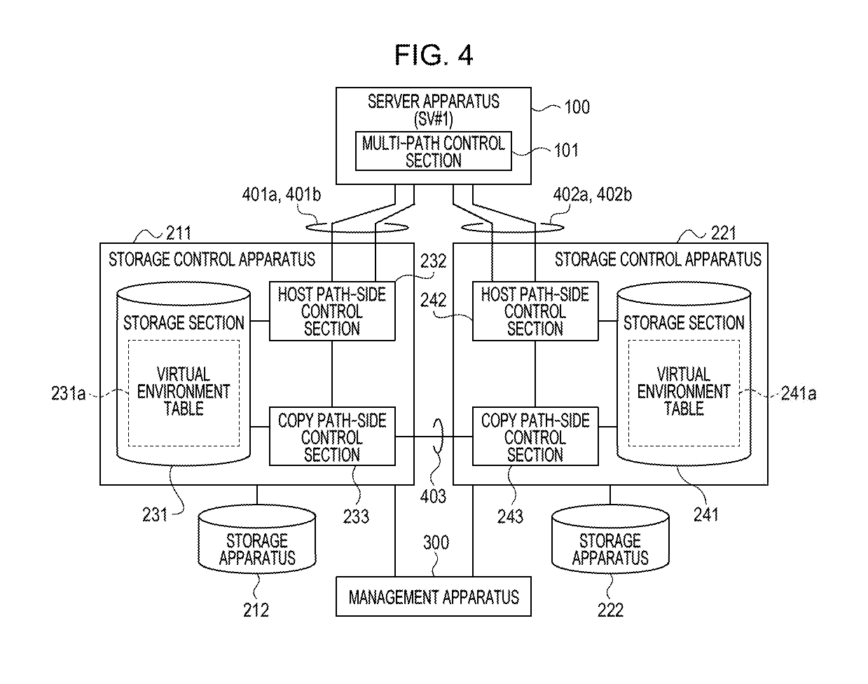

Subsequently, the functions of the server apparatus 100 and the storage control apparatuses 211 and 221 will be described with reference to FIG. 4. FIG. 4 is a diagram illustrating an example of the functions of the server apparatus and the storage control apparatuses according to the second embodiment.

First, the functions of the server apparatus 100 will be described.

As illustrated in FIG. 4, the server apparatus 100 includes a multi-path control section 101. It is possible to realize the functions of the multi-path control section 101 using the above-described CPU 902 or the like. The multi-path control section 101 controls the connection states of the paths 401a, 401b, 402a, and 402b.

For example, in a case where a process (linking-up) of causing a host path to be in a connection state is performed, the multi-path control section 101 receives a notification of identification information (apparatus ID) which identifies a storage control apparatus which may be accessed through the host path. In addition, the multi-path control section 101 receives a notification of identification information (LU-ID) which identifies an LU which may be accessed through the host path. The multi-path control section 101 manages the host path, the apparatus ID, and the LU-ID in association with each other.

The multi-path control section 101 performs scheduling of access for each host path on the basis of the apparatus ID and the LU-ID which are managed for each host path. For example, when a plurality of access requests are sent to the same LU of a storage control apparatus having the same apparatus ID, the multi-path control section 101 equally arranges the access requests for the respective host paths in a case where there is a plurality of host paths corresponding to the apparatus ID and the LU-ID.

There is a case in which a control technology for improving access performance by arranging the access requests to the plurality of host paths in a dispersion manner is referred to as multi-path control.

As a multi-path control method, for example, there is a method of arranging access requests to each host path by considering the communication loads on each host path, the processing loads on the storage control apparatuses, and the like, such that loads are equal, in addition to a method of equally arranging access requests to each host path. In addition, a method of setting priorities and acceptable loads for each host path and arranging access requests in accordance with the setting in dispersion manner is conceivable.

It is possible to apply various multi-path control as described above to the multi-path control section 101. The multi-path control section 101 may distinguish between the types (read request/write request) of the access request and may switch a multi-path control method depending on the type.

In a case where the number of host paths to be controlled is increased, flexibility in control increases, and thus it is expected that the access performance is improved as much as the loads on the communication path including the interface, such as the HBA and the CA, and the communication line are dispersed. Therefore, in a case where host paths, among the host paths in the storage system, which have not been previously used for the multi-path control due to the system configuration, are enabled to be availably utilized, it contributes to improving the performance.

Subsequently, the functions of the storage control apparatus 211 will be described. For convenience of explanation, it is assumed that the storage control apparatus 211 is set to the copy source of synchronization copy.

As illustrated in FIG. 4, the storage control apparatus 211 includes a storage section 231, a host path-side control section 232, and a copy path-side control section 233.

It is possible to realize the functions of the storage section 231 using the above-described RAM 906, the storage section 920, or the like. It is possible to realize the functions of the host path-side control section 232 and the copy path-side control section 233 using the above-described CPU 902 or the like.

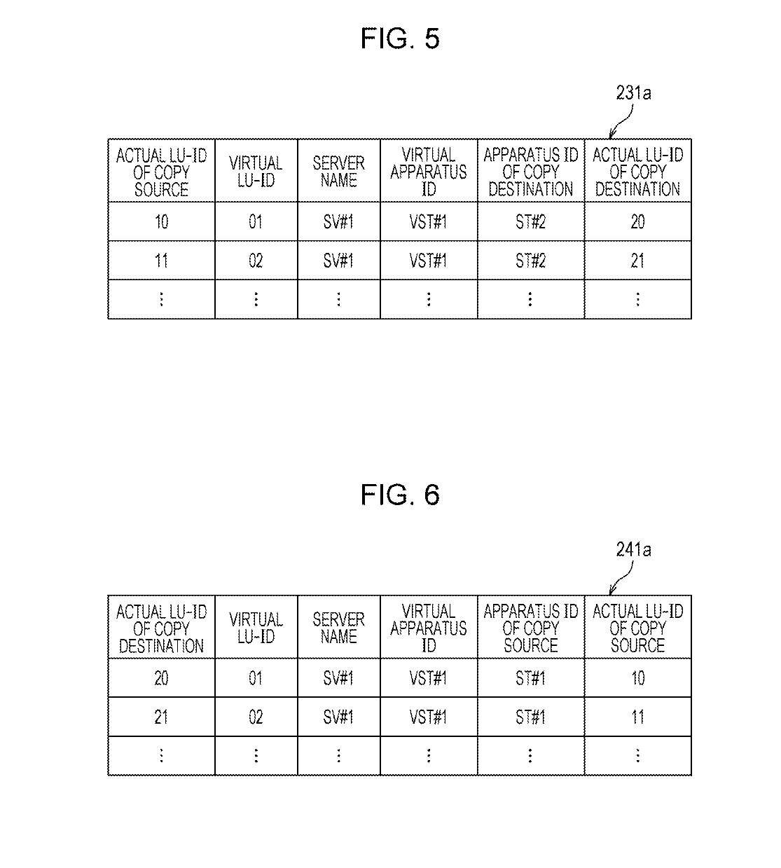

The storage section 231 stores therein a virtual environment table 231a as illustrated in FIG. 5. FIG. 5 is a diagram illustrating an example of the virtual environment table (copy source) according to the second embodiment.

The virtual environment table 231a maintains an apparatus ID (virtual apparatus ID) which identifies a common virtual storage control apparatus (virtual apparatus) which is set to the storage control apparatus 211 serving as the copy source and the storage control apparatus 221 serving as the copy destination by the management apparatus 300. In addition, the virtual environment table 231a maintains an LU-ID (virtual LU-ID) which identifies a common virtual LU which is set to an LU (actual LU) pair, which is present as the copy source and the copy destination, by the management apparatus 300.

The virtual environment table 231a associates the virtual LU-ID with the virtual apparatus ID. The virtual environment table 231a associates an apparatus ID (apparatus ID of the copy destination) of the storage control apparatus 221 serving as the copy destination with the virtual apparatus ID. The virtual environment table 231a associates an LU-ID (actual LU-ID of the copy source), which identifies the LU of the copy source, and an LU-ID (actual LU-ID of the copy destination), which identifies the LU of the copy destination, with the virtual LU-ID. The virtual environment table 231a maintains the server name of the server apparatus 100 which uses the virtual LU.

That is, the virtual environment table 231a maintains the actual LU- ID of the copy source, the virtual LU-ID, the server name of the server apparatus 100 which uses the virtual LU, the virtual apparatus ID, the apparatus ID of the copy destination, and the actual LU-ID of the copy destination in association with each other. For example, the virtual environment table 231a is used to identify an LU pair to be subject to a synchronization copy. In addition, the virtual environment table 231a is used to replace an access to a virtual LU with an access to an actual LU.

The host path-side control section 232 controls the operations of the CAs to which the paths 401a and 401b are connected. The host path-side control section 232 notifies the virtual apparatus ID, which is maintained by the virtual environment table 231a, to the server apparatus 100 in a case where the respective paths 401a and 401b are linked-up. Through the notification, the server apparatus 100 recognizes that the paths 401a and 401b are connected to a storage control apparatus (virtual apparatus) which is indicated by the virtual apparatus ID.

The host path-side control section 232 notifies the virtual LU-ID, which is maintained by the virtual environment table 231a, to the server apparatus 100 in a case where an LU recognition process triggered by the linking-up is performed on the respective paths 401a and 401b. Through the notification, the server apparatus 100 recognizes that it is possible to access an LU (virtual LU), which is indicated by the virtual LU-ID, through the paths 401a and 401b.

In a case where the host path-side control section 232 receives an access to a virtual LU by the server apparatus 100, the host path-side control section 232 replaces the address of the virtual LU, which is the access destination, with an address of an actual LU using the virtual environment table 231a, thereby performing a process for the actual LU. In a case where a process for the actual LU of the copy destination is performed, the host path-side control section 232 performs the process in cooperation with the copy path-side control section 233. In a case where the process is completed, the host path-side control section 232 returns a reply in response to the access request to the server apparatus 100.

The copy path-side control section 233 controls the operation of the RA to which the path 403 is connected. For example, the copy path-side control section 233 transfers data, which is to be written in an actual LU of the copy destination, through the path 403. In a case where data, which is read from an actual LU of the copy destination, is received through the path 403, the copy path-side control section 233 inputs the received data to the host path-side control section 232. A control method performed by the host path-side control section 232 and the copy path-side control section 233 will be further described later.

Subsequently, the functions of the storage control apparatus 221 will be described. For convenience of explanation, it is assumed that the storage control apparatus 221 is set to the copy destination of the synchronization copy.

As illustrated in FIG. 4, the storage control apparatus 221 includes a storage section 241, a host path-side control section 242, and a copy path-side control section 243.

It is possible to realize the functions of the storage section 241 using the above-described RAM 906, the storage section 920, or the like. It is possible to realize the functions of the host path-side control section 242 and the copy path-side control section 243 using the above-described CPU 902 or the like.

The storage section 241 stores a virtual environment table 241a as illustrated in FIG. 6. FIG. 6 is a diagram illustrating an example of the virtual environment table (copy destination) according to the second embodiment.

The virtual environment table 241a maintains an apparatus ID (virtual apparatus ID) which identifies a common virtual storage control apparatus (virtual apparatus) which is set to the storage control apparatus 211 serving as the copy source and the storage control apparatus 221 serving as the copy destination by the management apparatus 300. In addition, the virtual environment table 241a maintains an LU-ID (virtual LU-ID) which identifies a common virtual LU (virtual LU) which is set to an LU (actual LU) pair, which is present as the copy source and the copy destination, by the management apparatus 300.

The virtual environment table 241a associates the virtual LU-ID with the virtual apparatus ID. The virtual environment table 241a associates the apparatus ID (apparatus ID of the copy source) of the storage control apparatus 211 serving as the copy source with the virtual apparatus ID. The virtual environment table 241a associates an LU-ID (actual LU-ID of the copy source), which identifies an LU of the copy source, and an LU-ID (actual LU-ID of the copy destination), which identifies an LU of the copy destination, with the virtual LU-ID. The virtual environment table 241a maintains the server name of the server apparatus 100 which uses the virtual LU.

That is, the virtual environment table 241a maintains the actual LU- ID of the copy destination, the virtual LU-ID, the server name of the server apparatus 100 which uses the virtual LU, the virtual apparatus ID, the apparatus ID of the copy source, and the actual LU-ID of the copy source in association with each other. For example, the virtual environment table 241a is used to identify an LU pair to be subject to a synchronization copy. In addition, the virtual environment table 241a is used to replace an access to a virtual LU with an access to an actual LU.

The host path-side control section 242 controls the operations of the CAs to which the paths 402a and 402b are connected. The host path-side control section 242 notifies the virtual apparatus ID, which is maintained by the virtual environment table 241a, to the server apparatus 100 in a case where the respective paths 402a and 402b are linked-up. Through the notification, the server apparatus 100 recognizes that the paths 402a and 402b are connected to a storage control apparatus (virtual apparatus) which is indicated by the virtual apparatus ID.

The host path-side control section 242 notifies the virtual LU-ID, which is maintained by the virtual environment table 241a, to the server apparatus 100 in a case where an LU recognition process on the basis of linking- up is performed on the respective paths 402a and 402b. Through the notification, the server apparatus 100 recognizes that it is possible to access an LU (virtual LU), which is indicated by the virtual LU-ID, through the paths 402a and 402b.

In a case where the host path-side control section 242 receives an access to a virtual LU by the server apparatus 100, the host path-side control section 242 replaces the address of the virtual LU, which is the access destination, with an address of an actual LU using the virtual environment table 241a, thereby performing a process for the actual LU. In a case where a process for the actual LU of the copy source is performed, the host path-side control section 242 performs the process in cooperation with the copy path-side control section 243. In a case where the process is completed, the host path-side control section 242 returns a reply in response to the access request to the server apparatus 100.

The copy path-side control section 243 controls the operation of the RA to which the path 403 is connected. For example, the copy path-side control section 243 transfers data, which is to be written in an actual LU of the copy source, through the path 403. In a case where data, which is read from the actual LU of the copy source, is received through the path 403, the copy path-side control section 243 inputs the received data to the host path-side control section 242. A control method performed by the host path-side control section 242 and the copy path-side control section 243 will be further described later.

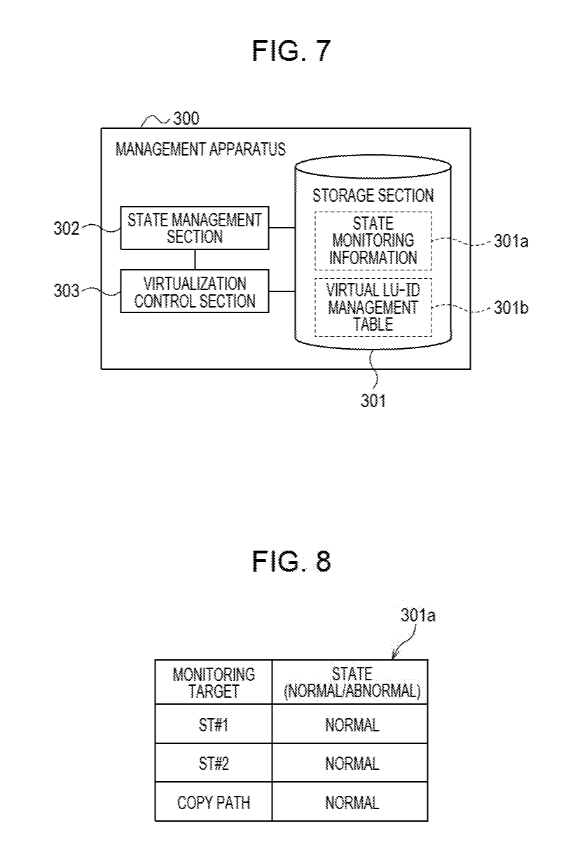

Subsequently, the functions of the management apparatus 300 will be described with reference to FIG. 7. FIG. 7 is a diagram illustrating an example of the functions of the management apparatus according to the second embodiment.

As illustrated in FIG. 7, the management apparatus 300 includes a storage section 301, a state management section 302, and a virtualization control section 303. It is possible to realize the functions of the storage section 301 using the above-described RAM 906, the storage section 920, or the like. It is possible to realize the functions of the state management section 302 and the virtualization control section 303 using the above-described CPU 902 or the like.

The storage section 301 stores therein state monitoring information 301a and a virtual LU-ID management table 301b. As illustrated in FIG. 8, the state monitoring information 301a indicates the states of the monitoring targets, that is, storage control apparatuses 211 and 221 (ST#1 and ST#2) and the path 403 (copy path). FIG. 8 is a diagram illustrating an example of the state monitoring information according to the second embodiment.

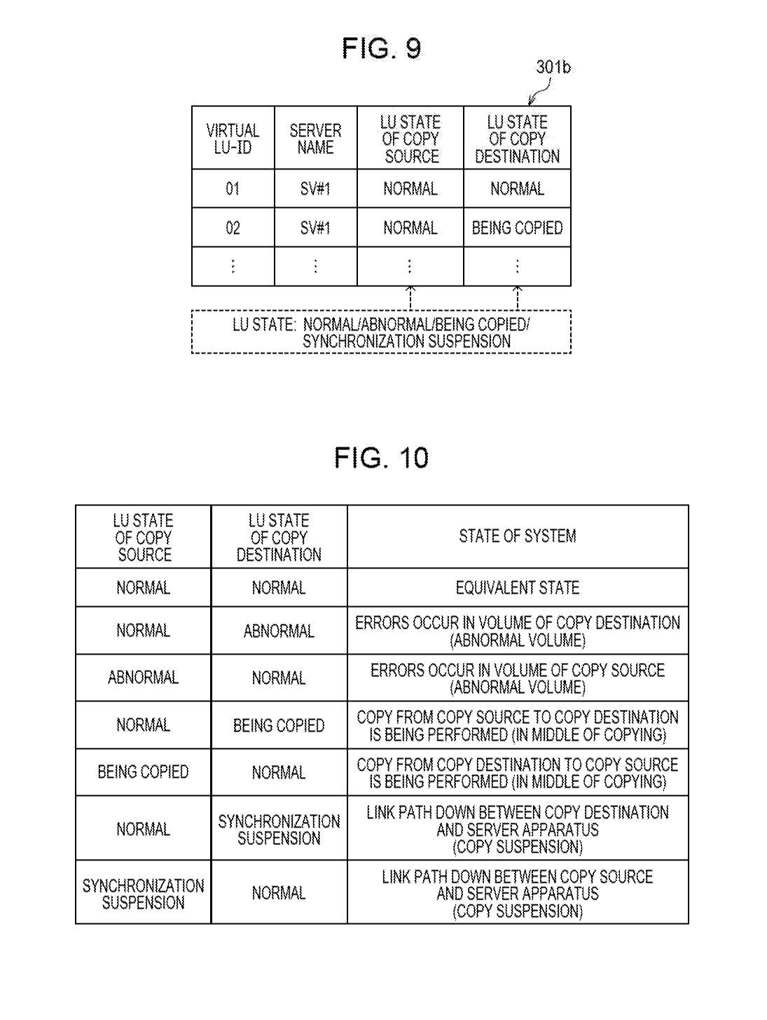

As illustrated in FIG. 9, the virtual LU-ID management table 301b associates, for each virtual LU, a virtual LU-ID, the server name of the server apparatus 100 which uses the virtual LU, the state of the actual LU of the copy source (LU state of the copy source), and the state of the actual LU of the copy destination (LU state of the copy destination). FIG. 9 is a diagram illustrating an example of the virtual LU-ID management table according to the second embodiment.

Each of the LU state of the copy source and the LU state of the copy destination may represent any one of “normal”, “abnormal”, “being copied”, and “synchronization suspension”. The “normal” indicates a state in which read/write of data is normally performed for an LU. The “abnormal” indicates a state in which abnormality occurs in an area of a physical volume, to which an LU is allocated, and read/write of data is not normally performed for the LU. The “being copied” indicates a halfway state in which the synchronization copy process is being performed. The “synchronization suspension” indicates that abnormalities occur in a copy path and the synchronization copy is in a suspended state.

For example, correspondence relationships as illustrated in FIG. 10 is generated between combinations of the LU state of the copy source and the LU state of the copy destination and the state of the system. FIG. 10 is a diagram illustrating the relationships between combinations of the LU state of the copy source and the LU state of the copy destination and the state of the system.

In a case where both the LU state of the copy source and the LU state of the copy destination are “normal”, the state of the system is in an “equivalent state”. The “equivalent state” indicates a state in which the synchronization copy is completed and identical data is stored in the LUs which form the copy pair.

In a case where the LU state of the copy source is “normal” and the LU state of the copy destination is “abnormal”, the state of the system is in an “abnormal volume” state. In this case, the “abnormal volume” state indicates a state in which write or read errors occur in the volume of the copy destination (physical volume to which the LU of the copy destination is allocated).

In a case where the LU state of the copy destination is “normal” and the LU state of the copy source is “abnormal”, the state of the system is in an “abnormal volume” state. In this case, the “abnormal volume” state indicates a state in which write or read errors occur in the volume of the copy source (physical volume to which the LU of the copy source is allocated).

In a case where the LU state of the copy source is “normal” and the LU state of the copy destination is “being copied”, the state of the system is in a “in the middle of copying” state. In this case, the “in the middle of copying” state indicates a state in which the copy process from an LU of the copy source to an LU of the copy destination is being performed. In this state, data, which is not yet copied from the LU of the copy source to the LU of the copy destination, exists.

In a case where the LU state of the copy destination is “normal” and the LU state of the copy source is “being copied”, the state of the system is in a “in the middle of copying” state. In this case, the “in the middle of copying” state indicates a state in which the copy process from an LU of the copy destination to an LU of the copy source is being performed. In this state, data, which is not yet copied from the LU of the copy destination to the LU of the copy source, exists.

In a case where the LU state of the copy source is “normal” and the LU state of the copy destination is “synchronization suspension”, the state of the system is in a “copy suspension” state. In this case, the “copy suspension” state indicates a state in which the host paths (paths 402a and 402b), which connect the storage control apparatus 221 serving as the copy destination to the server apparatus 100, are disconnected.

In a case where the LU state of the copy destination is “normal” and the LU state of the copy source is “synchronization suspension”, the state of the system is in a “copy suspension” state. In this case, the “copy suspension” state indicates a state in which the host paths (paths 401a and 401b), which connect the storage control apparatus 211 serving as the copy source to the server apparatus 100, are disconnected.

The state management section 302 monitors the states of the storage control apparatuses 211 and 221 and the path 403, and manages the result of the monitoring as the state monitoring information 301a. In addition, the state management section 302 monitors the states (the LU state of the copy source and the LU state of the copy destination) of the actual LUs to which the virtual LU-IDs are set, and reflects the result of the monitoring to the virtual LU-ID management table 301b.

The virtualization control section 303 performs processes relevant to virtualization of the storage control apparatuses 211 and 221 and the actual LU. For example, the virtualization control section 303 sets the virtual apparatus IDs and the virtual LU-IDs, and notifies the set virtual apparatus IDs and the virtual LU-IDs to the storage control apparatuses 211 and 221.

Hereinabove, the functions of the server apparatus 100 and the storage control apparatuses 211 and 221 have been described.

Here, a response process for the write request and the read request in each of the states of the system including the “equivalent state”, “abnormal volume”, “in the middle of copying”, and “copy suspension” will be described.

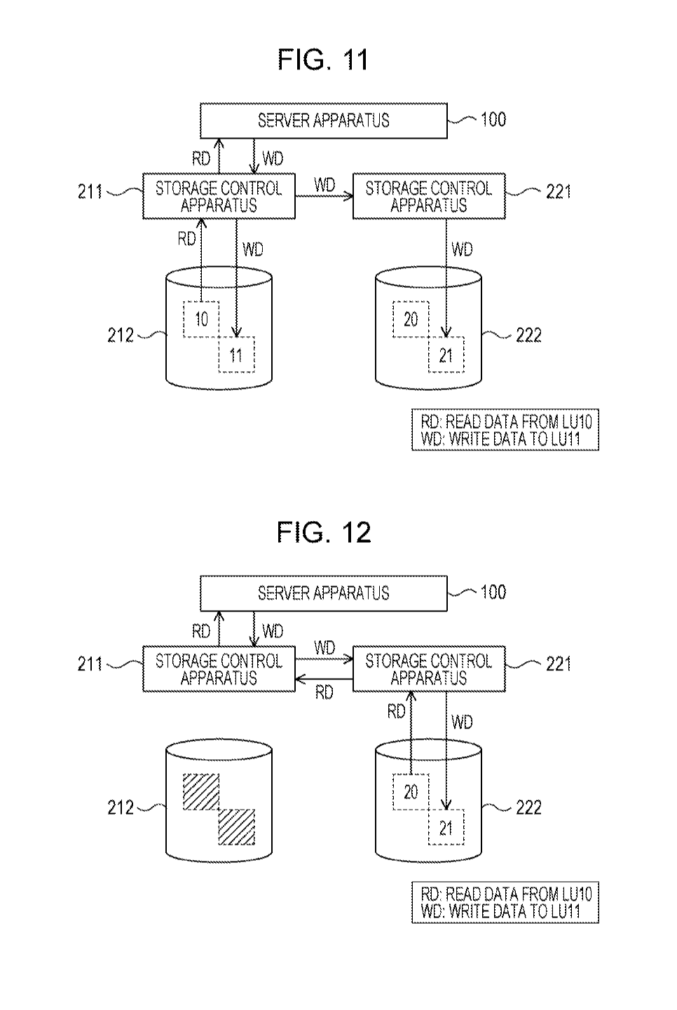

A case in which the state of the system is the “equivalent state” will be described with reference to FIG. 11. FIG. 11 is a diagram illustrating an example of an operation (at “equivalent state”) of the storage control apparatus according to the second embodiment.

In the example of FIG. 11, RD indicates data (read data) to be read from an LU (LU10) having an LU-ID of “10”. WD indicates data (write data) to be written to an LU (LU11) having an LU-ID of “11”. An LU (LU20) having an LU-ID of “20” and LU10 form a copy pair, and an LU (LU21) having an LU-ID of “21” and LU11 form a copy pair. LU10 and LU20 are in a synchronized state (equivalent state). LU11 and LU21 are in a synchronized state (equivalent state).

In a case where a read request which instructs to read RD from LU10 is received from the server apparatus 100, the host path-side control section 232 of the storage control apparatus 211 reads RD from LU10 which is managed by the host path-side control section 232, and responds to the server apparatus 100 using the read RD.

In a case where a write request, which includes an instruction to write WD to LU11, is received from the server apparatus 100, the host path-side control section 232 of the storage control apparatus 211 writes WD to LU11, which is managed by the host path-side control section 232, and inputs WD to the copy path-side control section 233. The copy path-side control section 233, to which WD is input, transfers WD to the storage control apparatus 221 through the path 403.

The copy path-side control section 243 of the storage control apparatus 221, which has received the transferred WD, writes WD to LU21 which forms a copy pair together with LU11. When the writing is completed, the copy path-side control section 243 returns a completion notification to the storage control apparatus 211 through the path 403. The completion notification is input to the host path-side control section 232 through the copy path-side control section 233. The host path-side control section 232, which has received the completion notification, returns a completion notification, which indicates that the process of writing WD is completed, to the server apparatus 100.

Subsequently, a case in which the state of the system is “abnormal volume” will be described with reference to FIG. 12. FIG. 12 is a diagram illustrating an example of an operation (at “abnormal volume”) of the storage control apparatus according to the second embodiment. The example of FIG. 12 indicates a case in which abnormalities occur in the physical volumes, to which LU10 and LU11 are allocated and it is difficult to perform normal access to LU10 and LU11.

In a case where a read request, which instructs to read RD from LU10, is received from the server apparatus 100, the host path-side control section 232 of the storage control apparatus 211 requests, through the copy path-side control section 233, the storage control apparatus 221 to read RD. The copy path-side control section 243 of the storage control apparatus 221, which has received the request, reads RD from LU20 which forms a copy pair together with LU10.

The copy path-side control section 243 transfers RD to the storage control apparatus 211 through the path 403. The copy path-side control section 233, which has received RD, inputs RD to the host path-side control section 232. The host path-side control section 232, which has received RD, responds to the server apparatus 100 using RD which has been read from LU20.

In a case where a write request, which includes an instruction to write WD to LU11, is received from the server apparatus 100, the host path-side control section 232 of the storage control apparatus 211 requests, through the copy path-side control section 233, the storage control apparatus 221 to write WD. The copy path-side control section 243 of the storage control apparatus 221, which has received the request, writes WD to LU21 which forms a copy pair together with LU11.

When the writing is completed, the copy path-side control section 243 returns a completion notification to the storage control apparatus 211 through the path 403. The completion notification is input to the host path-side control section 232 through the copy path-side control section 233. The host path-side control section 232, which has received the completion notification, returns a completion notification, which indicates that the process of writing WD is completed, to the server apparatus 100.

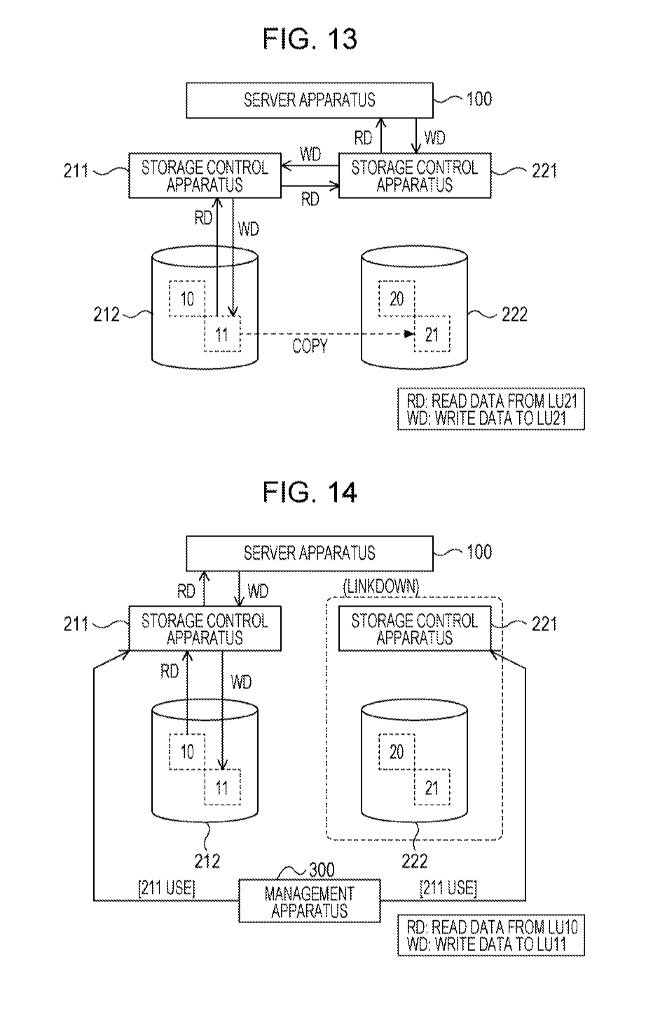

Subsequently, a case in which the state of the system is “in the middle of copying” with reference to FIG. 13. FIG. 13 is a diagram illustrating an example of an operation (at “in the middle of copying”) of the storage control apparatus according to the second embodiment.

The example of FIG. 13 indicates a case in which an access to LU21 occurs in the middle of copying the data of LU11 into LU21 and an area to be accessed is an area which is not yet copied. In a case where the area to be accessed is an area which is already copied, the same process as in the “equivalent state” is performed. In the example of FIG. 13, RD indicates data (read data) to be read from LU21 on the assumption that LU11 and LU21 are in a synchronized state. WD indicates data (write data) to be written to LU21.

In a case where a read request, which instructs to read RD from LU21, is received from the server apparatus 100, the host path-side control section 242 of the storage control apparatus 221 requests, through the copy path-side control section 243, the storage control apparatus 211 to read RD, which is to be subject to synchronization copy into LU21, from LU11. The copy path-side control section 233 of the storage control apparatus 211, which has received the request, reads RD from LU11.

The copy path-side control section 233 transfers RD to the storage control apparatus 221 through the path 403. The copy path-side control section 243, which has received RD, inputs RD to the host path-side control section 242. The host path-side control section 242, which has received RD, responds to the server apparatus 100 using RD which has been read from LU11.

In a case where a write request, which includes an instruction to write WD to LU21, is received from the server apparatus 100, the host path-side control section 242 of the storage control apparatus 221 requests, through the copy path-side control section 243, the storage control apparatus 211 to write WD. The copy path-side control section 233 of the storage control apparatus 211, which has received the request, writes WD to LU11 which forms a copy pair together with LU21.

When the writing is completed, the copy path-side control section 233 returns a completion notification to the storage control apparatus 221 through the path 403. The completion notification is input to the host path-side control section 242 through the copy path-side control section 243. The host path-side control section 242, which has received the completion notification, returns a completion notification, which indicates that the process of writing WD is completed, to the server apparatus 100. Thereafter, the data, which has been written to LU11, is written to LU21 by synchronization copy.

Subsequently, a case in which the state of the system is “copy suspension” will be described with reference to FIG. 14. FIG. 14 is a diagram illustrating an example of an operation (at “copy suspension”) of the storage control apparatus according to the second embodiment. The example of FIG. 14 indicates a case in which abnormalities occur in a copy path (path 403) and host paths (paths 402a and 402b), which connect the storage control apparatus 221 to the server apparatus 100, have been linked down by an instruction of the management apparatus 300.

In a case where the state management section 302 of the management apparatus 300 detects abnormalities of the path 403, the virtualization control section 303 determines which of the storage control apparatuses 211 and 221 is to be used. When it is determined to use the storage control apparatus 211, the virtualization control section 303 notifies the result of the determination to the storage control apparatuses 211 and 221. The storage control apparatus 221, which has received the notification, links down the paths 402a and 402b connecting the storage control apparatus 221 with the server apparatus 100. Therefore, access by the server apparatus 100 is performed to the storage control apparatus 211.

In a case where the state management section 302 detects the restoration of the path 403, the virtualization control section 303 instructs the storage control apparatus 221 to link up the paths 402a and 402b. The virtualization control section 303 instructs the storage control apparatuses 211 and 221 to synchronize data between LU10 and LU20 and between LU11 and LU21. Accesses occurred in the middle of the synchronization process are performed as the same as in the case of “in the middle of copying”. After the synchronization is completed, the accesses are performed as the same as in the case of “equivalent state”.

Hereinabove, the response process depending on the state of the system has been described.

Subsequently, flows of processes will be described with respect to settings of a virtual LU and a virtual apparatus, a response to an access request for a virtual LU, and the like.

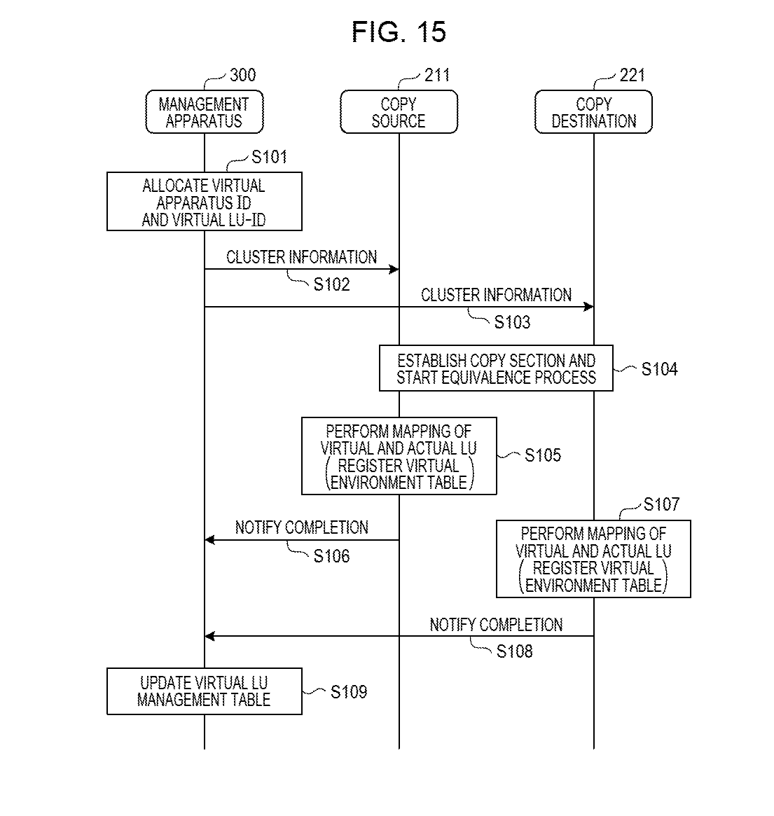

First, a setting process of a virtual LU and a virtual apparatus will be described with reference to FIG. 15. FIG. 15 is a sequence diagram illustrating a flow of a virtualization setting process according to the second embodiment.

The virtualization control section 303 of the management apparatus 300 allocates a virtual apparatus ID to the storage control apparatuses 211 and 221 (S101). In addition, the virtualization control section 303 selects an actual LU pair, which is to be subject to synchronization copy, from among actual LUs which are managed by the storage control apparatuses 211 and 221. Furthermore, the virtualization control section 303 allocates a virtual LU-ID to the selected actual LU pair.

The virtualization control section 303 transfers cluster information to the storage control apparatus 211 which is set be a copy source (S102). The cluster information includes apparatus IDs (an apparatus ID of the copy source and an apparatus ID of a copy destination) of the storage control apparatuses 211 and 221, to which the virtual apparatus ID is allocated, and the virtual apparatus ID. The cluster information also includes LU-IDs (the actual LU-ID of the copy source and the actual LU-ID of the copy destination) of the actual LUs to which the virtual LU-ID is allocated, the virtual LU-ID, and a server name of the server apparatus 100 which uses the virtual LU.

The virtualization control section 303 transfers cluster information, which is the same as the cluster information that is sent to the storage control apparatus 211, to the storage control apparatus 221 which is set to be the copy destination (S103).

The copy path-side control section 233 of the storage control apparatus 211 and the copy path-side control section 243 of the storage control apparatus 221 establish a copy section (S104). Furthermore, the copy path-side control sections 233 and 243 start an equivalence process of synchronizing the actual LU, which is indicated by the actual LU-ID of the copy source, with the actual LU which is indicated by the actual LU-ID of the copy destination.

The host path-side control section 232 of the storage control apparatus 211 registers the cluster information, which has been received from the management apparatus 300, in the virtual environment table 231a (S105). That is, the host path-side control section 232 registers the actual LU-ID of the copy source, the virtual LU-ID, the virtual apparatus ID, the apparatus ID of the copy destination, the actual LU-ID of the copy destination, and the server name, which are included in the cluster information, in the virtual environment table 231a (mapping of the virtual and actual LUs).

The host path-side control section 232 provides a notification indicating that the mapping process for the virtual and actual LUs is completed to the management apparatus 300 (S106).

The host path-side control section 242 of the storage control apparatus 221 registers the cluster information, which has been received from the management apparatus 300, in the virtual environment table 241a (S107). That is, the host path-side control section 242 registers the actual LU-ID of the copy destination, the virtual LU-ID, the virtual apparatus ID, the apparatus ID of the copy source, the actual LU-ID of the copy source, and the server name, which are included in the cluster information, in the virtual environment table 241a (mapping of the virtual and actual LUs).

The host path-side control section 242 provides a notification indicating that the mapping process for the virtual and actual LUs is completed to the management apparatus 300 (S108).

The virtualization control section 303 registers the virtual LU-ID, which is allocated to the actual LUs that are managed by the storage control apparatuses 211 and 221, and the server name of the server apparatus 100, which uses the virtual LU that is indicated by the virtual LU-ID, in the virtual LU-ID management table 301b (S109).

The virtualization control section 303 acquires information, which indicates the LU state of the copy source and the LU state of the copy destination, detected by the state management section 302, and updates the virtual LU-ID management table 301b on the basis of the acquired information. When the process in S109 is completed, a series of processes illustrated in FIG. 15 ends.

After the virtualization setting process illustrated in FIG. 15 is completed, the host path-side control sections 232 and 242 notify the virtual apparatus ID to the server apparatus 100 when the host paths are linked up, and respond to the server apparatus 100 with the virtual LU-IDs when the LUs are recognized. The host path-side control sections 232 and 242 manage the LUs, to which the virtual LU-IDs are allocated, as the virtual LUs of the virtual apparatuses.

The server apparatus 100 recognizes the storage control apparatuses 211 and 221 as one storage control apparatus, and recognizes the two actual LUs, to which the virtual LU-IDs are allocated, as one actual LU. Furthermore, the multi-path control section 101 of the server apparatus 100 performs the multi-path control on the paths 401a, 401b, 402a, and 402b. Therefore, since the number of host paths subject to the multi-path control, the number of interfaces connected to the host paths, and the number of actual LUs are increased, the loads are dispersed, thereby improving access performance.

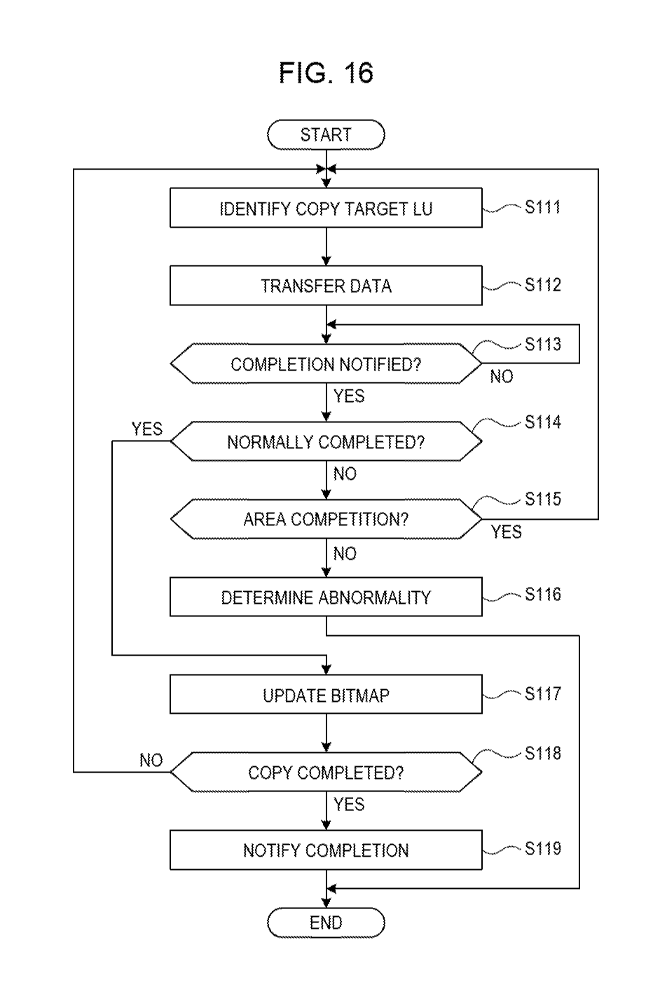

Subsequently, a flow of an equivalence process will be described with reference to FIG. 16. FIG. 16 is a flowchart illustrating the flow of the equivalence process according to the second embodiment.

The copy path-side control section 233 of the storage control apparatus 211 (copy source) identifies an actual LU (copy target LU) to be subject to the equivalence process (S111). The copy path-side control section 233 registers the state (an address until which copy is completed) of progress of the equivalence process to a bitmap. Therefore, the copy path-side control section 233 may identify an actual LU, which is not yet copied, as the copy target LU (target LU) on the basis of the bitmap.

The copy path-side control section 233 transfers the data of the target LU toward the storage control apparatus 221 serving as the copy destination which is registered in the virtual environment table 231a (S112). At this time, the copy path-side control section 233 transfers data, which is not yet copied, to the storage control apparatus 221 with reference to the bitmap.

The copy path-side control section 233 determines whether or not the completion notification is received from the storage control apparatus 221 serving as the copy destination (S113). In a case where the completion notification is received, the process proceeds to S114. In contrast, in a case where the completion notification is not received, the process proceeds to S113 again. That is, the copy path-side control section 233 waits for the completion notification. In a case where the completion notification is not sent even though a preset time elapsed, the copy path-side control section 233 may ends the series of processes by determining that errors have occurred.

The copy path-side control section 233 determines whether or not the copy is normally completed with reference to the received completion notification (S114). In a case where the copy is normally completed, the process proceeds to S117. In contrast, in a case where the copy is not normally completed, the process proceeds to S115.

The copy path-side control section 233 determines whether or not a reason that the copy is not normally completed is due to area competition (S115).

The actual LUs of the copy target are virtualized, data may be simultaneously written to both of the actual LUs, and the data which is written to one actual LU is also written to the other actual LU for synchronization. Therefore, for the areas of the actual LUs in which identical data is to be written, a synchronization request from the copy source to the copy destination and a synchronization request from the copy destination to the copy source may be simultaneously occurred. In such a situation, the copy path-side control section 233 determines that area competition is occurred.

In a case of being dependent on the area competition, the process proceeds to S111. In a case of being independent on the area competition, the process proceeds to S116.

The copy path-side control section 233 determines that the target LU of the copy destination is abnormal (S116). When the process in S116 is completed, the series of processes, illustrated in FIG. 16, ends.

The copy path-side control section 233 reflects the area, of which the copy is completed, to the bitmap to update the bitmap (S117).

The copy path-side control section 233 determines whether or not synchronization copy is completed (copy completion) for every LU subject to the copy with reference to the bitmap (S118). In a case where every LU has been copied, the process proceeds to S119. In contrast, in a case where an LU, on which the copy is not yet completed, is present, the process proceeds to S111.

The copy path-side control section 233 notifies the completion of the equivalence process to the management apparatus 300 (S119). When the process in S119 is completed, the series of processes illustrated in FIG. 16 ends.

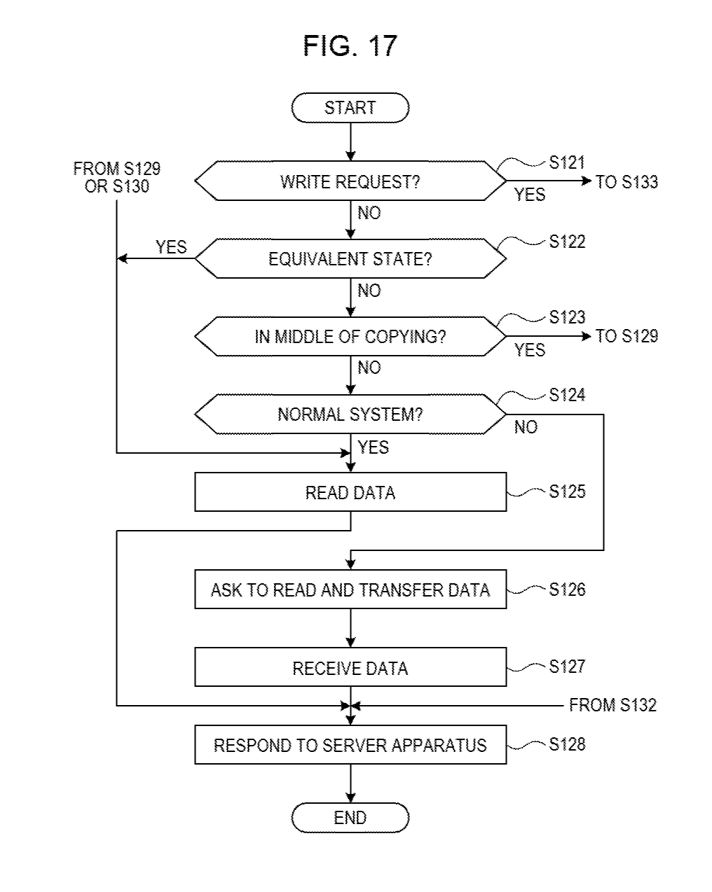

Subsequently, processes in response to an access request (host request), which is received from the server apparatus 100 through the host path, will be described with reference to FIGS. 17 to 20.

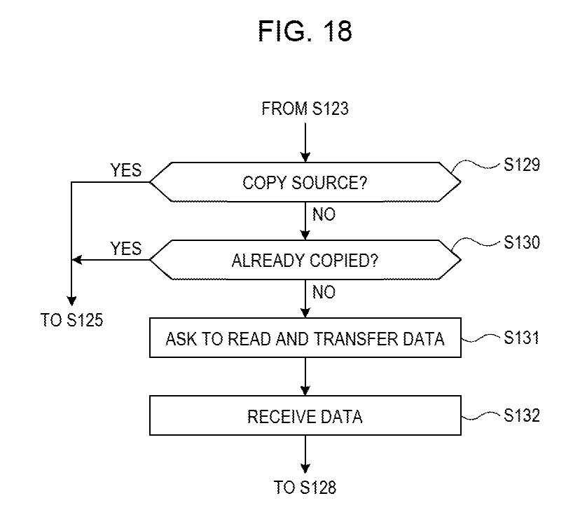

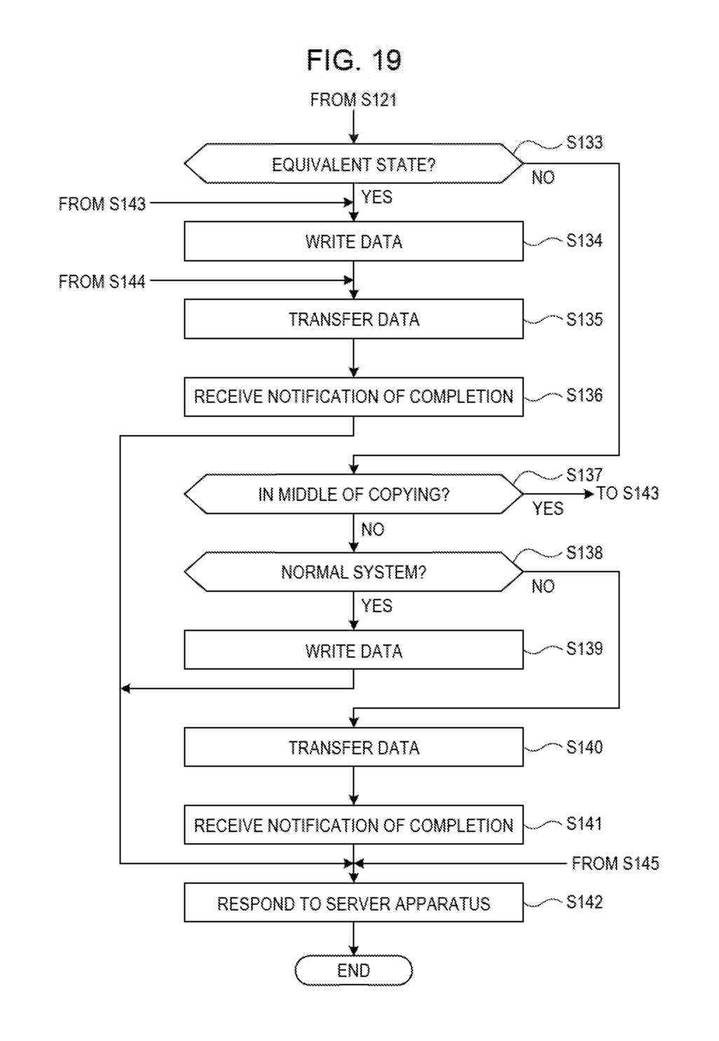

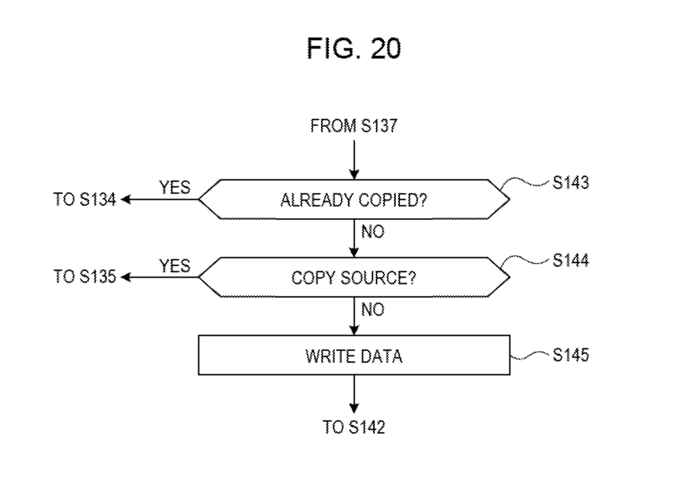

FIG. 17 is a first flowchart illustrating a flow of a process in response to a host request according to the second embodiment. FIG. 18 is a second flowchart illustrating a flow of a process in response to the host request according to the second embodiment. FIG. 19 is a third flowchart illustrating a flow of a process in response to the host request according to the second embodiment. FIG. 20 is a fourth flowchart illustrating a flow of a process in response to the host request according to the second embodiment.

Here, for convenience of explanation, a case in which the storage control apparatus 211 receives a host request will be described. However, in a case where the storage control apparatus 221 receives the host request, the subject of the process is changed from the storage control apparatus 211 to the storage control apparatus 221. In addition, here, it is assumed that the host request, which is received by the storage control apparatus 211, is for a virtual LU.

The host path-side control section 232 determines whether or not the host request, which is received from the server apparatus 100, is a write request (S121). In a case where the host request is a write request, the process proceeds to S133 of FIG. 19. In contrast, in a case where the host request is not a write request (in a case of a read request), the process proceeds to S122.

The host path-side control section 232 identifies actual LUs corresponding to the virtual LU designated by the read request with reference to the virtual environment table 231a (S122). Furthermore, the host path-side control section 232 determines whether or not the identified actual LUs are in the “equivalent state”. In a case where the actual LUs are in the “equivalent state”, the process proceeds to S125. In contrast, in a case where the actual LUs are not in the “equivalent state”, the process proceeds to S123.

The host path-side control section 232 determines whether or not the actual LUs corresponding to the virtual LU designated by the read request are in the state of “in the middle of copying” (S123). In a case where the actual LUs are in the state of “in the middle of copying”, the process proceeds to S129 of FIG. 18. In contrast, in a case where the actual LUs are not in the state of “in the middle of copying”, the process proceeds to S124. In a case where the actual LUs are in neither the “equivalent state” nor the state of “in the middle of copying”, the state of the system is “copy suspension” due to the abnormalities of the path 403 or “abnormal volume”.

The host path-side control section 232 determines whether or not the storage control apparatus 211 is a normal system (normally operating state) (S124). In a case of being a normal system, the process proceeds to S125. In contrast, in a case of not being a normal system (a case in which abnormalities occur), the process proceeds to S126. For example, in a case where failures occur in the physical volume corresponding to the actual LU and errors occur when the data is read/written (a case of abnormal volume), it is determined that the storage control apparatus 211 is not a normal system.

The host path-side control section 232 reads data, which is designated by the read request, from the actual LU managed by the storage control apparatus 211 (S125). When the process in S125 is completed, the process proceeds to S128.

The host path-side control section 232 requests, through the copy path-side control section 233, the counter party (storage control apparatus 221) to read and transfer the data which is designated by the read request (S126).

The host path-side control section 232 receives, through the copy path-side control section 233, the requested data from the counter party (storage control apparatus 221) (S127).

The host path-side control section 232 responds to the server apparatus 100 using the data which is acquired through the process in S125, S127, or S132 (S128). When the process in S128 is completed, the series of processes illustrated in FIGS. 17 to 20 ends.

The host path-side control section 232 determines whether or not the storage control apparatus 211 is the copy source (S129). In a case where the storage control apparatus 211 is the copy source, the process proceeds to S125. In contrast, in a case where the storage control apparatus 211 is not the copy source (in a case of the copy destination), the process proceeds to S130. In the example, since the storage control apparatus 211 is the copy source, the process proceeds to S125.

The host path-side control section 232 determines whether or not the actual LU corresponding to the virtual LU (target LU) designated by the read request is already copied (S130). In a case where the target LU is already copied, the process proceeds to S125. In contrast, in a case where the target LU is not yet copied, the process proceeds to S131.

The host path-side control section 232 requests, through the copy path-side control section 233, the counter party (storage control apparatus 221) to read and transfer the data which is designated by the read request (S131).

The host path-side control section 232 receives, through the copy path-side control section 233, the requested data from the counter party (storage control apparatus 221) (S132). When the process in S132 is completed, the process proceeds to S128.

The host path-side control section 232 identifies actual LUs corresponding to the virtual LU designated by the write request with reference to the virtual environment table 231a (S133). The host path-side control section 232 determines whether or not the identified actual LUs are in the “equivalent state”. In a case where the actual LUs are in the “equivalent state”, the process proceeds to S134. In contrast, in a case where the actual LUs are not in the “equivalent state”, the process proceeds to S137.

The host path-side control section 232 writes the data of the write target to the actual LU which is managed by the storage control apparatus 211 (S134).

The host path-side control section 232 transfers the data of the write target to the counter party (storage control apparatus 221) through the copy path-side control section 233 (S135).

The host path-side control section 232 receives, through the copy path-side control section 233, a notification (completion notification), which indicates that the data transferred in S135 is completely written, from the counter party (storage control apparatus 221) (S136). When the process in S136 is completed, the process proceeds to S142.

The host path-side control section 232 determines whether or not the actual LUs corresponding to the virtual LU designated by the write request are in the state of “in the middle of copying” (S137). In a case where the actual LUs are in the state of “in the middle of copying”, the process proceeds to S143 of FIG. 20. In contrast, in a case where the actual LUs are not in the state of “in the middle of copying”, the process proceeds to S138. In a case where the actual LUs are in neither the “equivalent state” nor the state of “in the middle of copying”, the state of the system is “copy suspension” due to the abnormalities of the path 403 or “abnormal volume”.

The host path-side control section 232 determines whether or not the storage control apparatus 211 is a normal system (normally operating state) (S138). In a case of being a normal system, the process proceeds to S139. In contrast, in a case of not being a normal system (a case in which abnormalities occur), the process proceeds to S140. For example, in a case where failures occur in the physical volume corresponding to the actual LU and errors occur when the data is read/written (a case of the abnormal volume), it is determined that the storage control apparatus 211 is not a normal system.

The host path-side control section 232 writes the data of the write target to the actual LU managed by the storage control apparatus 211 (S139). When the process in S139 is completed, the process proceeds to S142.

The host path-side control section 232 transfers the data of the write target to the counter party (storage control apparatus 221) through the copy path-side control section 233 (S140).

The host path-side control section 232 receives, through the copy path-side control section 233, a notification (completion notification), which indicates that the writing of the data transferred in S140 is completed, from the counter party (storage control apparatus 221) (S141).

The host path-side control section 232 sends a notification, which indicates that the writing is completed, to the server apparatus 100 to respond to the write request (S142). When the process in S142 is completed, the series of processes illustrated in FIGS. 17 to 20 ends.

The host path-side control section 232 determines whether or not the actual LU (target LU) corresponding to the virtual LU designated by the write request is already copied (S143). In a case where the target LU is already copied, the process proceeds to S134. In contrast, in a case where the target LU is not yet copied, the process proceeds to S144.

The host path-side control section 232 determines whether or not the storage control apparatus 211 is the copy source (S144). In a case where the storage control apparatus 211 is the copy source, the process proceeds to S135. In contrast, in a case where the storage control apparatus 211 is not the copy source (in a case of the copy destination), the process proceeds to S145. In the example, since the storage control apparatus 211 is the copy source, the process proceeds to S135.

The host path-side control section 232 writes the data of the write target to the actual LU managed by the storage control apparatus 211 (S145). When the process in S145 is completed, the process proceeds to S142.

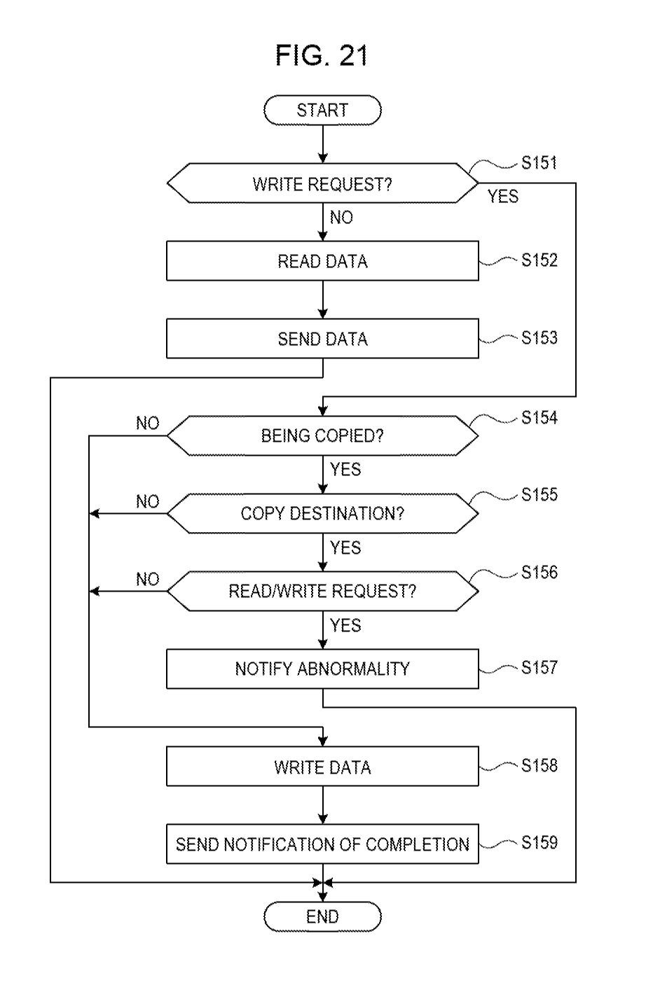

Subsequently, a process in response to an access request (counter party request), which is received from the counter party through the copy path, will be described with reference to FIG. 21. The counter party request corresponds to a data read/write request or a transfer request which is received, through the path 403, from the counter party that has received a host request for a virtual LU. FIG. 21 is a flowchart illustrating a process in response to a counter party request according to the second embodiment.

Here, for convenience of explanation, a case in which the storage control apparatus 211 receives the counter party request will be described. However, for a case in which the storage control apparatus 221 receives the counter party request, the subject of the process is changed from the storage control apparatus 211 to the storage control apparatus 221.

The copy path-side control section 233 determines whether or not the counter party request, which is received from the counter party (storage control apparatus 221) through the path 403, is a write request (S151). In a case where the counter party request is a write request, the process proceeds to S154. In contrast, in a case where the counter party request is not a write request (in a case of a read request), the process proceeds to S152.

The copy path-side control section 233 reads data, which is designated by the counter party request, from the actual LU managed by the storage control apparatus 211 (S152).

The copy path-side control section 233 sends the data, which has been read in S152, to the counter party (storage control apparatus 221) through the path 403 (S153). When the process in S153 is completed, the series of processes illustrated in FIG. 21 ends.

The copy path-side control section 233 determines whether or not the actual LU, which is designated by the counter party request, is in the state of the “being copied” (S154). In a case where the actual LU is in the state of the “being copied”, the process proceeds to S155. In contrast, in a case where the actual LU is not in the state of the “being copied”, the process proceeds to S158.

The copy path-side control section 233 determines whether or not the storage control apparatus 211 is the copy destination (S155). In a case where the storage control apparatus 211 is the copy destination, the process proceeds to S156. In contrast, in a case where the storage control apparatus 211 is not the copy destination (in a case of the copy source), the process proceeds to S158.

The copy path-side control section 233 determines whether or not a read request or a write request is issued for an actual LU of the counter party (storage control apparatus 221), which forms a virtual LU together with the actual LU (target LU) designated by the counter party request (S156). That is, the copy path-side control section 233 determines whether or not a reverse counter party request toward the counter party has been issued, from the copy path-side control section 233, for the actual LU of the counter party, which forms a copy pair with the target of the counter party request received by the copy path-side control section 233.

In a case where a read request or a write request has been issued toward the counter party (in a case where the area competition occurs), the process proceeds to S157. In contrast, in a case where a read request or a write request has not been issued toward the counter party, the process proceeds to S158.

The copy path-side control section 233 notifies abnormalities due to the area competition to the counter party (storage control apparatus 221) (S157). When the process in S157 is completed, the series of processes illustrated in FIG. 21 ends.

The copy path-side control section 233 writes data in the actual LU managed by the storage control apparatus 211 (S158).

The copy path-side control section 233 sends a notification (completion notification), which indicates that the data is completely written, to the counter party (storage control apparatus 221) (S159). When the process in S159 is completed, the series of processes illustrated in FIG. 21 ends.

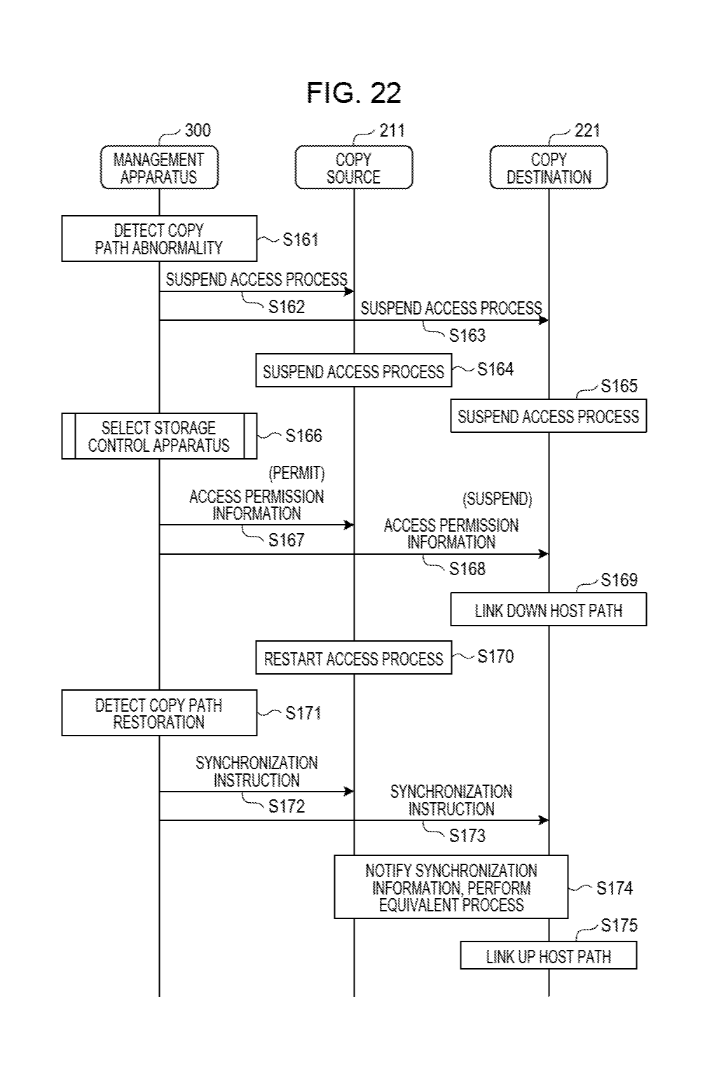

Subsequently, a process which is performed in a case where abnormalities occur in a copy path and the copy path is restored will be described with reference to FIG. 22. FIG. 22 is a sequence diagram illustrating a flow of the process performed in a case where abnormalities occur in a copy path and the copy path is restored according to the second embodiment.

Here, for convenience of explanation, it is assumed that the storage control apparatus 211 is the copy source and the storage control apparatus 221 is the copy destination.

The state management section 302 of the management apparatus 300 detects abnormalities in a copy path (path 403) (S161).

The virtualization control section 303 of the management apparatus 300 instructs the storage control apparatus 211 serving as the copy source to suspend an access process (S162). That is, the virtualization control section 303 causes the storage control apparatus 211 to temporarily suspend a process for responding to the host request.

The virtualization control section 303 instructs the storage control apparatus 221 serving as the copy destination to suspend an access process (S163). That is, the virtualization control section 303 causes the storage control apparatus 221 to temporarily suspend a process for responding to the host request.

The host path-side control section 232 of the storage control apparatus 211 suspends the access process (S164). That is, the host path-side control section 232 suspends the process for responding to the host request.

The host path-side control section 242 of the storage control apparatus 221 suspends the access process (S165). That is, the host path-side control section 242 suspends the process for responding to the host request.

The virtualization control section 303 selects a storage control apparatus to be used (S166). In a case where abnormalities occur in a copy path, it is difficult to maintain the equivalent state between the actual LUs which form the virtual LU, and thus the virtualization control section 303 once stops the parallel operation of the storage control apparatuses 211 and 221, and operates one storage control apparatus. Thus, the virtualization control section 303 selects one storage control apparatus to be operated. Here, for convenience of explanation, it is assumed that the storage control apparatus 211 is selected.

The virtualization control section 303 sends access permission information, which indicates a notification indicating that the access process is permitted, to the storage control apparatus 211 (S167). That is, the virtualization control section 303 notifies that the storage control apparatus 211 is used to respond to the host request and the storage control apparatus 221 does not respond to the host request.

The virtualization control section 303 sends access permission information, which indicates a notification indicating that the access process is suspended, to the storage control apparatus 221 (S168). That is, the virtualization control section 303 notifies that the storage control apparatus 211 is used to respond to the host request and the storage control apparatus 221 does not respond to the host request.

The host path-side control section 242 of the storage control apparatus 221 receives the access permission information and links down the host paths (paths 402a and 402b) (S169).

The host path-side control section 232 of the storage control apparatus 211 restarts the access process in order to respond to the host request (S170). At this time, the host path-side control section 232 reflects an updated content to the bitmap which indicates an updated area in a case where a write access to the actual LU is occurred.

The state management section 302 detects restoration of the copy path (path 403) (S171).

The virtualization control section 303 instructs (synchronization instruction) the storage control apparatus 211 to synchronize data between the actual LUs which form a copy pair (S172).

The virtualization control section 303 instructs (synchronization instruction) the storage control apparatus 221 to synchronize data between the actual LUs which form a copy pair (S173).

The copy path-side control section 233 (copy source) sends the bitmap (synchronization information notification) to the storage control apparatus 221 in order to notify the areas of the actual LU which are updated while the storage control apparatus 221 is suspending the access process (S174). The copy path-side control sections 233 and 243 start the equivalence process (refer to FIG. 16) on the basis of the bitmap.

The host path-side control section 242 (copy destination) links up the host paths (paths 402a and 402b) which are linked down in S169 (S175).

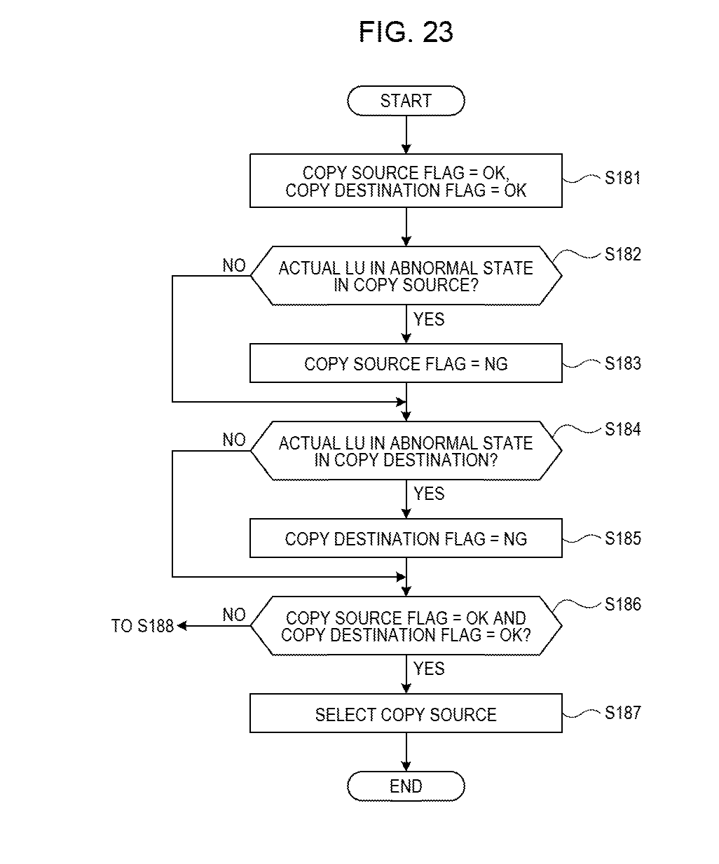

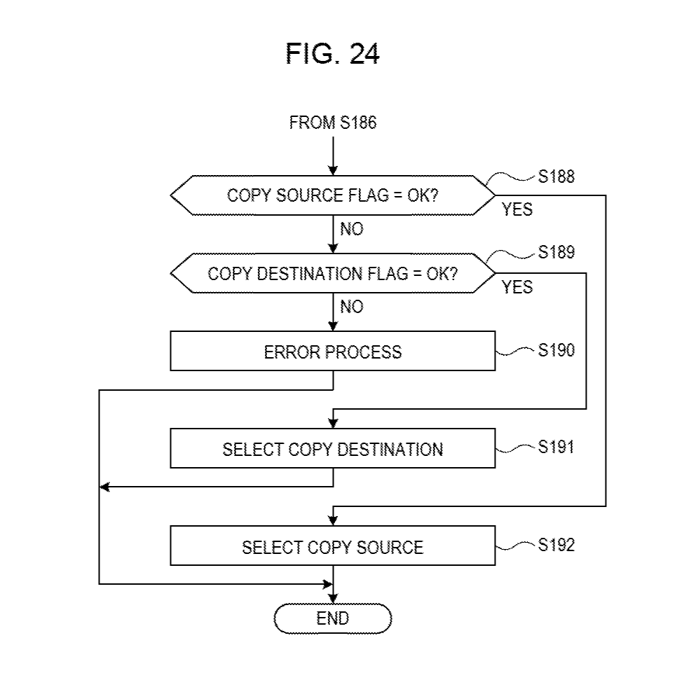

Here, the process (S166) of selecting a storage control apparatus to be used will be further described with reference to FIGS. 23 and 24. FIG. 23 is a first flowchart illustrating a flow of the process of selecting an apparatus to be used according to the second embodiment. FIG. 24 is a second flowchart illustrating a flow of the process of selecting an apparatus to be used according to the second embodiment.

The virtualization control section 303 of the management apparatus 300 initializes a copy source flag and a copy destination flag (the copy source flag=OK and the copy destination flag=OK) (S181).

The virtualization control section 303 determines whether or not actual LUs of the copy source, which correspond to virtual LUs, include an actual LU in an abnormal state with reference to the virtual LU-ID management table 301b (S182). In a case where the actual LUs of the copy source include an actual LU in an abnormal state, the process proceeds to S183. In a case where the actual LUs of the copy source include no actual LU in an abnormal state, the process proceeds to S184.

The virtualization control section 303 sets the copy source flag to NG (S183).

The virtualization control section 303 determines whether or not actual LUs of the copy destination, which correspond to virtual LUs, include an actual LU in an abnormal state with reference to the virtual LU-ID management table 301b (S184). In a case where the actual LUs of the copy destination include an actual LU in an abnormal state, the process proceeds to S185. In a case where the actual LUs of the copy destination include no actual LU in an abnormal state, the process proceeds to S186.

The virtualization control section 303 sets the copy destination flag to NG (S185).

The virtualization control section 303 determines whether or not the copy source flag is OK and the copy destination flag is OK (S186). In a case where the “copy source flag is OK and the copy destination flag is OK”, the process proceeds to S187. In contrast, in a case where the state of the “copy source flag is OK and the copy destination flag is OK” is not obtained, the process proceeds to S188 of FIG. 24.

The virtualization control section 303 selects, as the storage control apparatus to be used, the storage control apparatus serving as the copy source (S187). When the process in S187 is completed, the series of processes illustrated in FIGS. 23 and 24 ends.

The virtualization control section 303 determines whether or not the copy source flag is OK (S188). In a case where the copy source flag is OK, the process proceeds to S192. In contrast, in a case where the copy source flag is not OK (in a case of NG), the process proceeds to S189.

The virtualization control section 303 determines whether or not the copy destination flag is OK (S189). In a case where the copy destination flag is OK, the process proceeds to S191. In contrast, in a case where the copy destination flag is not OK (in a case of NG), the process proceeds to S190.

The virtualization control section 303 performs an error process (S190). Since both the copy source flag and the copy destination flag are NG and the actual LUs of the copy source and the copy destination are in an abnormal state, both the actual LUs corresponding to the target virtual LU are in a state in which it is difficult to be normally managed. Therefore, the virtualization control section 303 performs the error process while assuming that no apparatus is available to be used. When the process in S190 is completed, the series of processes illustrated in FIGS. 23 and 24 ends.

The virtualization control section 303 selects, as the apparatus to be used, the storage control apparatus serving as the copy destination (S191). Since the copy source flag is NG and the copy destination flag is OK, that is, only the actual LU of the copy destination is in a state which may be normally managed, the storage control apparatus serving as the copy destination is selected, as the apparatus to be used, in order to continue the operation using the actual LU of the copy destination. When the process in S191 is completed, the series of processes illustrated in FIGS. 23 and 24 ends.

The virtualization control section 303 selects, as the apparatus to be used, the storage control apparatus serving as the copy source (S192). Since the copy source flag is OK and the copy destination flag is NG, that is, only the actual LU of the copy source is in the state which may be normally managed, the storage control apparatus serving as the copy source is selected, as the apparatus to be used, in order to continue the operation using the actual LU of the copy source. When the process in S192 is completed, the series of processes illustrated in FIGS. 23 and 24 ends.

Hereinabove, the second embodiment has been described.

As described so far, it is possible to regard two storage control apparatuses 211 and 221 as one virtual storage control apparatus by using the virtual apparatus ID, and it is possible to regard two actual LUs which are subject to synchronization copy as one virtual LU by using the virtual LU-ID. As a result, it is possible to manage the storage control apparatuses 211 and 221 which respectively include two host paths as one virtual storage control apparatus which includes four host paths.

In a case where the number of host paths increases, the flexibility of the multi-path control increases, and the access performance is further improved as much as loads applied to the communication path, which includes the interface, such as the HBA and the CA, and the communication line are dispersed. Furthermore, the read performance is improved as much as it is possible to access a plurality of actual LUs in the equivalent state in parallel. As described above, in a case where the technology according to the second embodiment is applied to the storage system in which the actual LUs are subject to synchronization copy for the purpose of back up, it is possible to improve the performance of the system.

### Third Embodiment

Subsequently, a third embodiment will be described. Although the storage system, which is connected to one server apparatus, has been supposed so far, the number of server apparatuses which are connected to the storage system may be two or more in a case where the virtualization technology according to the second embodiment is applied. Here, in the third embodiment, a method of applying the above-described virtualization technology to a storage system which is connected to two or more server apparatuses.

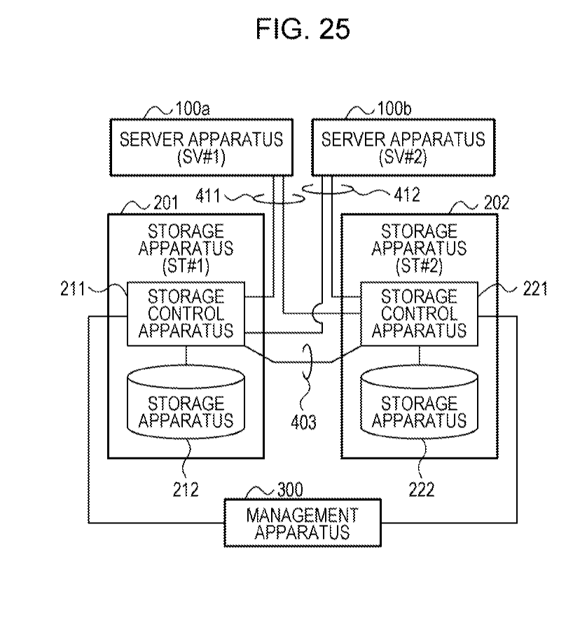

First, a storage system according to the third embodiment will be described with reference to FIG. 25. FIG. 25 is a diagram illustrating an example of the storage system according to the third embodiment.

As illustrated in FIG. 25, in the third embodiment, server apparatuses 100a and 100b are connected to the storage control apparatuses 211 and 221 through the host paths. Host paths 411 are connected to the server apparatus 100a. Host paths 412 are connected to the server apparatus 100b. The system configuration is substantially the same as the system configuration illustrated in FIG. 2, other than the number of server apparatuses. It is possible to realize the functions of the server apparatuses 100a and 100b using the hardware illustrated in FIG. 3.

Subsequently, the functions of the storage control apparatuses 211 and 221 and the management apparatus 300 according to the third embodiment will be described. Here, parts which are different from the second embodiment will be mainly described.

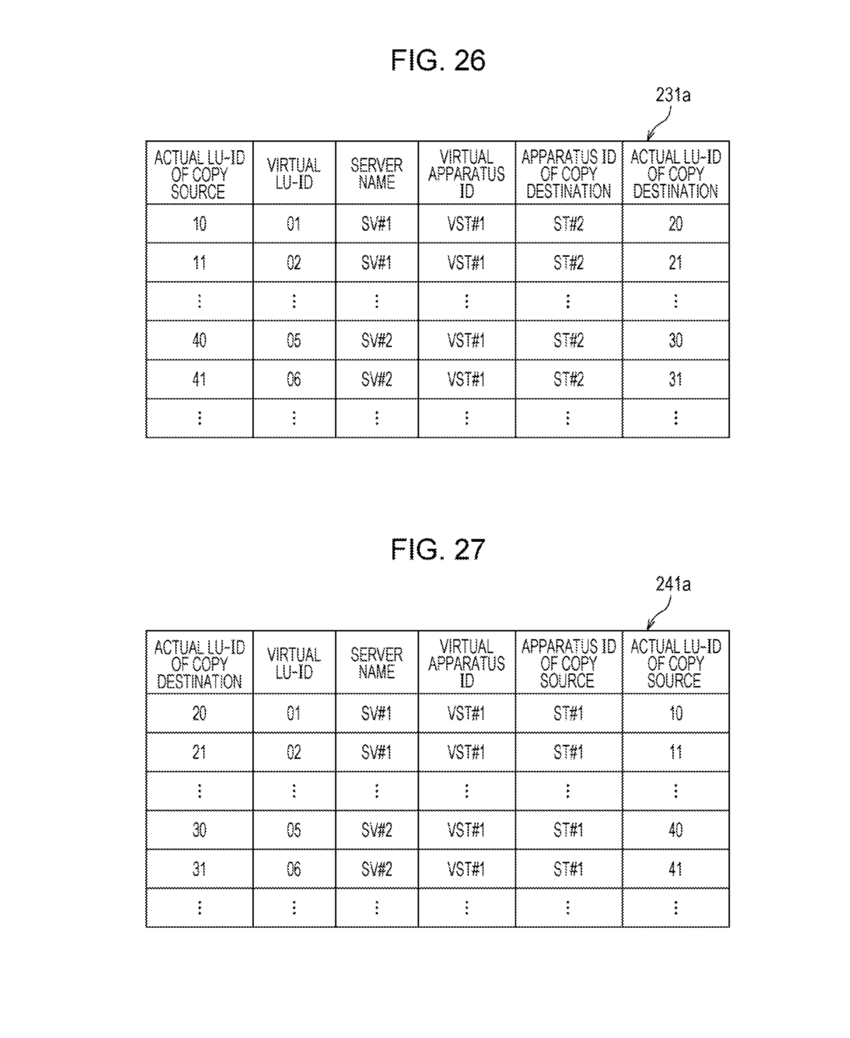

In a case where a plurality of server apparatuses are connected to the storage control apparatus 211, the virtual environment table 231a includes content as illustrated in FIG. 26 in order to manage the virtual apparatuses and the virtual LUs for each server apparatus. FIG. 26 is a diagram illustrating an example of a virtual environment table (copy source) according to the third embodiment. Pieces of information, such as the virtual apparatus ID and the virtual LU-ID, are notified from the management apparatus 300, together with the server name.

Similarly, in a case where a plurality of server apparatuses is connected to the storage control apparatus 221, the virtual environment table 241a includes content as illustrated in FIG. 27 in order to manage the virtual apparatuses and the virtual LUs for each server apparatus. FIG. 27 is a diagram illustrating an example of a virtual environment table (copy destination) according to the third embodiment. Pieces of information, such as the virtual apparatus ID and the virtual LU-ID, are notified from the management apparatus 300, together with the server name.

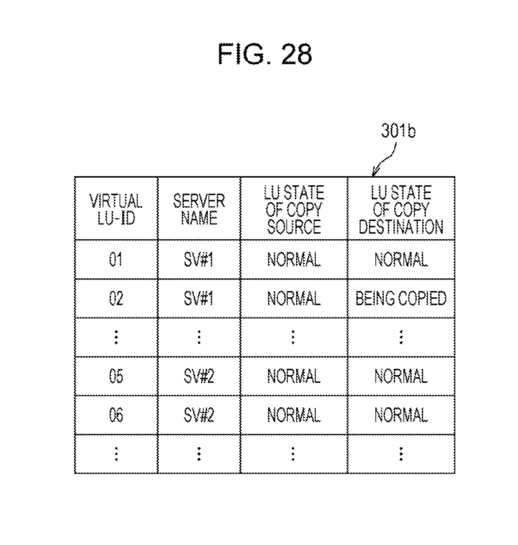

In a case where a plurality of server apparatuses is connected to the storage control apparatuses 211 and 221, the virtual LU-ID management table 301b is formed as illustrated in FIG. 28 in order to manage the states of the actual LUs allocated to the virtual LU (the LU state of the copy source and the LU state of the copy destination) for each server apparatus. FIG. 28 is a diagram illustrating an example of a virtual LU-ID management table according to the third embodiment.

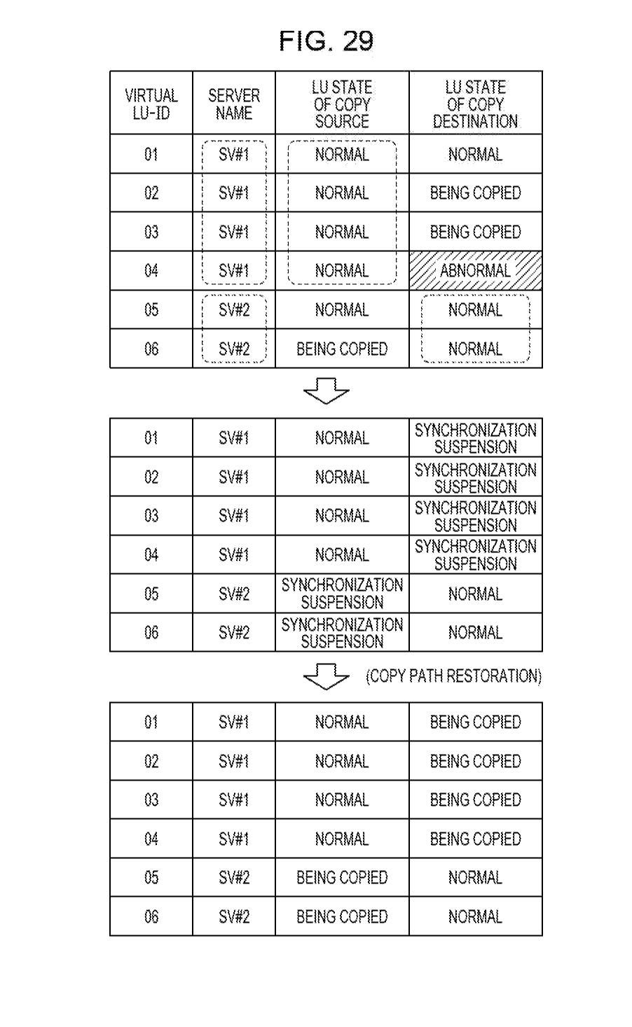

In the third embodiment, a part of the operation of the virtualization control section 303 included in the management apparatus 300 is extended. For example, in a case where abnormalities occur in a copy path and one storage control apparatus is selected, the virtualization control section 303 selects an appropriate storage control apparatus for each server apparatus depending on the LU state of the copy source and the LU state of the copy destination, as illustrated in FIG. 29. FIG. 29 is a diagram illustrating an example of an operation of the storage control apparatus and an example of transition of the virtual LU-ID management table according to the third embodiment.

An upper stage of FIG. 29 indicates an example of the virtual LU-ID management table 301b at a point of time in which the state management section 302 detects abnormalities of a copy path. In the example, all the actual LUs of the copy source, which form virtual LUs used by the server apparatus 100a having a server name SV#1, are in a normal state (refer to the LU state of the copy source). In contrast, all the actual LUs of the copy destination, which form virtual LUs used by the server apparatus 100b having a server name SV#2, are in a normal state (refer to the LU state of the copy destination).

In this case, the virtualization control section 303 selects the storage control apparatus 211 (copy source), in which all the actual LUs are normally managed, as the storage control apparatus to be used by the server apparatus 100a. In addition, the virtualization control section 303 selects the storage control apparatus 221 (copy destination), in which all the actual LUs are normally managed, as the storage control apparatus to be used by the server apparatus 100b.

As illustrated in the middle stage of FIG. 29, the virtualization control section 303 links down the host paths, which connect the server apparatus 100a (SV#1) to the storage control apparatus 221 (copy destination), and sets the LU state of the copy destination, which corresponds to the server name SV#1, to a “synchronization suspension” state. In addition, the virtualization control section 303 links down the host paths, which connect the server apparatus 100b (SV#2) to the storage control apparatus 211 (copy source), and sets the LU state of the copy source, which corresponds to the server name SV#2, to the “synchronization suspension” state.

In a case where the copy path is restored, the virtualization control section 303 performs a process of synchronizing the actual LUs, which form a copy pair, for each corresponding server apparatus as illustrated in the lower stage of FIG. 29.

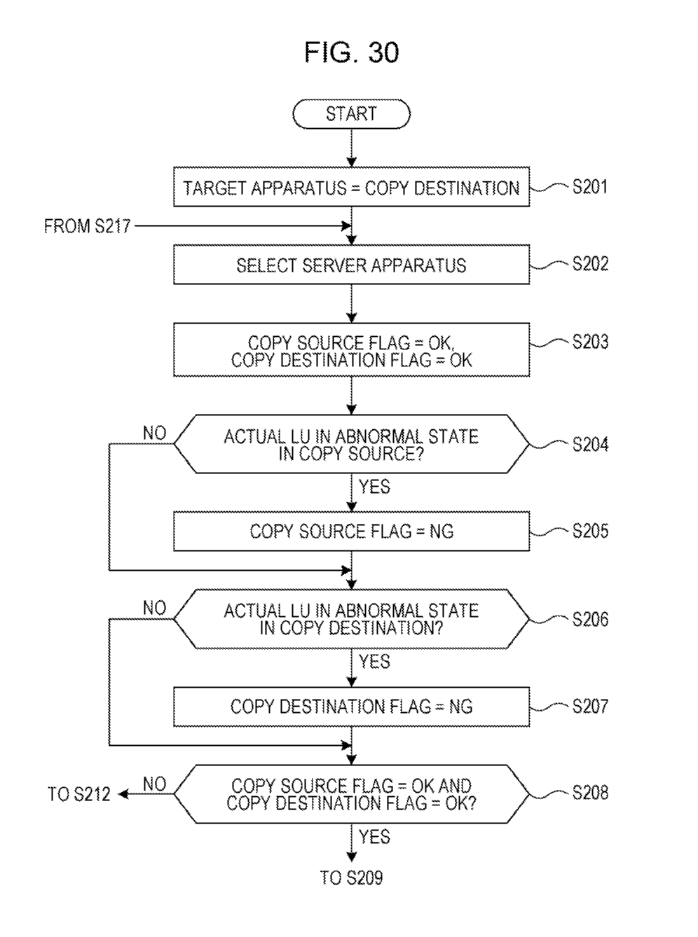

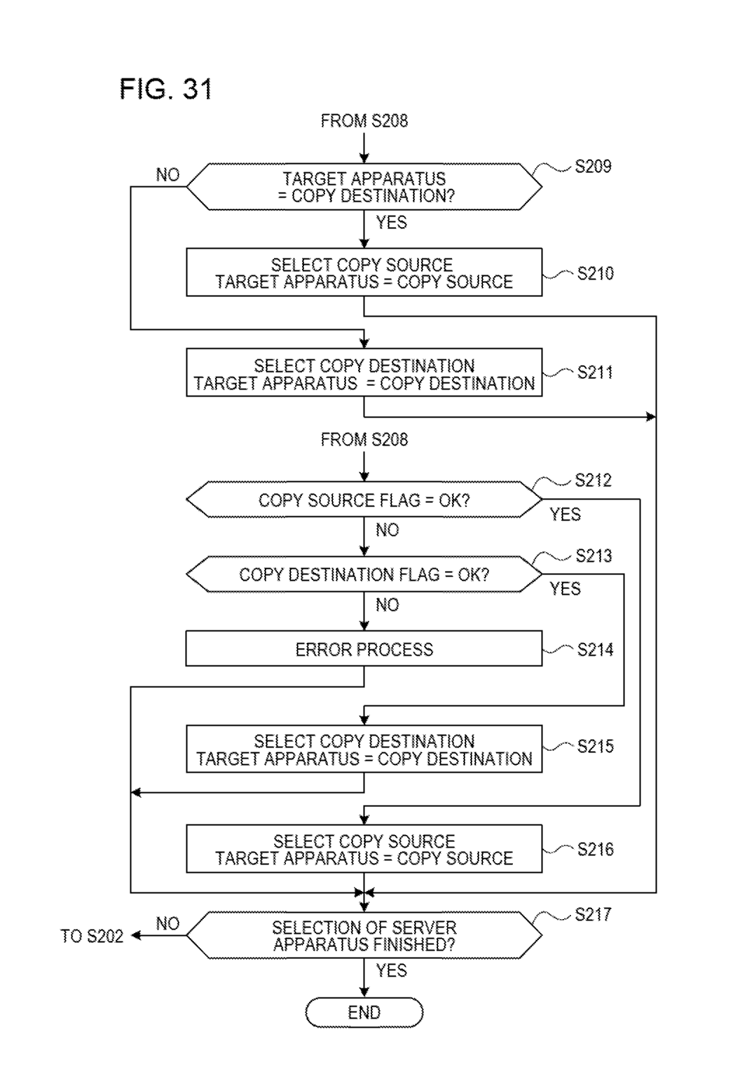

In the third embodiment, mainly, the process in S166 (processes of FIGS. 23 and 24) illustrated in FIG. 22 is changed. Here, a process of selecting an apparatus to be used according to the third embodiment will be described with reference to FIGS. 30 and 31. FIG. 30 is a first flowchart illustrating a flow of a process of selecting an apparatus to be used according to the third embodiment. FIG. 31 is a second flowchart illustrating a flow of a process of selecting the apparatus to be used according to the third embodiment.

The virtualization control section 303 of the management apparatus 300 sets a target apparatus to the copy destination (S201).

The virtualization control section 303 selects one server apparatus (S202).

The virtualization control section 303 initializes the copy source flag and the copy destination flag (the copy source flag=OK and the copy destination flag=OK) (S203).

The virtualization control section 303 determines, for the virtual LUs used by the server apparatus selected in S202, whether or not actual LUs of the copy source, which correspond to the virtual LUs, include an actual LU in an abnormal state with reference to the virtual LU-ID management table 301b (S204). In a case where the actual LUs of the copy source include an actual LU in an abnormal state, the process proceeds to S205. In a case where the actual LUs of the copy source include no actual LU in an abnormal state, the process proceeds to S206.

The virtualization control section 303 sets the copy source flag to NG (S205).

The virtualization control section 303 determines, for the virtual LUs used by the server apparatus selected in S202, whether or not actual LUs of the copy destination, which correspond to the virtual LUs, include an actual LU in an abnormal state with reference to the virtual LU-ID management table 301b (S206). In a case where the actual LUs of the copy destination include an actual LU in an abnormal state, the process proceeds to S207. In a case where the actual LUs of the copy destination include no actual LU in an abnormal state, the process proceeds to S208.

The virtualization control section 303 sets the copy destination flag to NG (S207).

The virtualization control section 303 determines whether or not the copy source flag is OK and the copy destination flag is OK (S208). In a case where the “copy source flag is OK and the copy destination flag is OK”, the process proceeds to S209 of FIG. 31. In contrast, in a case where the state of the “copy source flag is OK and the copy destination flag is OK” is not obtained, the process proceeds to S212 of FIG. 31.

The virtualization control section 303 determines whether or not the target apparatus is the copy destination (S209). In a case where the target apparatus is the copy destination, the process proceeds to S210. In contrast, in a case where the target apparatus is not the copy destination, the process proceeds to S211.

The virtualization control section 303 selects, as the storage control apparatus to be used, the storage control apparatus serving as the copy source (S210). In addition, the virtualization control section 303 sets the target apparatus to the copy source. When the process in S210 is completed, the process proceeds to S217.

The virtualization control section 303 selects, as the storage control apparatus to be used, the storage control apparatus serving as the copy destination (S211). In addition, the virtualization control section 303 sets the target apparatus to the copy destination. When the process in S211 is completed, the process proceeds to S217.

The virtualization control section 303 determines whether or not the copy source flag is OK (S212). In a case where the copy source flag is OK, the process proceeds to S216. In contrast, in a case where the copy source flag is not OK (in a case of NG), the process proceeds to S213.

The virtualization control section 303 determines whether or not the copy destination flag is OK (S213). In a case where the copy destination flag is OK, the process proceeds to S215. In contrast, in a case where the copy destination flag is not OK (in a case of NG), the process proceeds to S214.

The virtualization control section 303 performs an error process (S214). Since both the copy source flag and the copy destination flag are NG and the actual LUs of the copy source and the copy destination are in an abnormal state, both the actual LUs corresponding to the target virtual LU are in a state in which it is difficult to be normally managed. Therefore, the virtualization control section 303 performs the error process while assuming that no apparatus is available to be used. When the process in S214 is completed, the process proceeds to S217.

The virtualization control section 303 selects, as the apparatus to be used, the storage control apparatus serving as the copy destination (S215). Since the copy source flag is NG and the copy destination flag is OK, that is, only the actual LU of the copy destination is in a state which may be normally managed, the storage control apparatus serving as the copy destination is selected, as the apparatus to be used, in order to continue the management using the actual LU of the copy destination. In addition, the virtualization control section 303 sets the target apparatus to the copy destination. When the process in S215 is completed, the process proceeds to S217.

The virtualization control section 303 selects, as the apparatus to be used, the storage control apparatus serving as the copy source (S216). Since the copy source flag is OK and the copy destination flag is NG, that is, only the actual LU of the copy source is in a state which may be normally managed, the storage control apparatus serving as the copy source is selected, as the apparatus to be used, in order to continue management using the actual LU of the copy source. In addition, the virtualization control section 303 sets the target apparatus to the copy source. When the process in S216 is completed, the process proceeds to S217.

The virtualization control section 303 determines whether or not the selection of the server apparatus is finished (S217). In a case where the selection of all the server apparatuses is finished, the series of processes illustrated in FIGS. 30 and 31 ends. In contrast, there is a server apparatus which is not yet selected, the process proceeds to S202.

Hereinabove, the third embodiment has been described.

Similarly to the second embodiment, it is possible to regard two storage control apparatuses 211 and 221 as one virtual storage control apparatus by using the virtual apparatus ID, and it is possible to regard the two actual LUs, which are subject to synchronization copy, as one virtual LU by using the virtual LU-ID. As a result, it is possible to manage the storage control apparatuses 211 and 221 which respectively include two host paths as one virtual storage control apparatus which includes four host paths.

In a case where the number of host paths increases, the flexibility of the multi-path control increases, and the access performance is further improved as much as loads applied to the communication path, which includes the interface, such as the HBA and the CA, and the communication line are dispersed. Furthermore, the read performance is improved as much as it is possible to access a plurality of actual LUs in the equivalent state in parallel. As described above, in a case where the technology according to the third embodiment is applied to the storage system in which the actual LUs are subject to synchronization copy for the purpose of back up, it is possible to improve the performance of the system.

Furthermore, in a case where a mechanism in which a process which is performed in a case where abnormalities occur in a copy path is applied for each server apparatus, it is possible to use the above-described technology even in an environment in which a plurality of server apparatuses are connected to the system. In the above description, two storage apparatuses are managed by being connected to one or more server apparatuses as an example. However, it is possible to extend the number of storage apparatuses to three or more.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system, comprising:
a first storage control apparatus including:
a first storage device configured to
store therein first management information in which common apparatus information, common area information, and first area information are associated with each other, the common apparatus information identifying a virtual storage control apparatus, the common area information identifying a virtual storage area, the first area information identifying a first storage area, and
a first processor configured to
notify the common apparatus information and the common area information to a superordinate apparatus through a first path,
receive a request for a first access to access the virtual storage area from the superordinate apparatus through the first path, and
perform the first access on basis of the first management information;
a second storage control apparatus including:
a second storage device configured to
store therein second management information in which the common apparatus information, the common area information, and second area information are associated with each other, the second area information identifying a second storage area, and
a second processor configured to
notify the common apparatus information and the common area information to the superordinate apparatus through a second path,
receive a request for a second access to access the virtual storage area from the superordinate apparatus through the second path, and
perform the second access on basis of the second management information; and
a management apparatus including:
a third processor configured to
allocate the common apparatus information to the first storage control apparatus and the second storage control apparatus,
allocate the common area information to the first storage area and the second storage area, and
notify the common apparatus information and the common area information to the first storage control apparatus and the second storage control apparatus.

2. The storage system according to claim 1, wherein
the first processor is configured to
receive a request for a write access to write first data to the virtual storage area from the superordinate apparatus through the first path,
write the first data to the first storage area, and
transfer the first data to the second processor through a third path to copy the first data to the second storage area, and
the second processor is configured to
receive the first data through the third path, and
write the first data to the second storage area.

3. The storage system according to claim 2, wherein
the second processor is configured to
receive a request for a read access to read the first data stored in the virtual storage area from the superordinate apparatus through the second path,
determine whether the first data is already copied to the second storage area,
read, in a case where the first data is already copied, the first data from the second storage area to respond the superordinate apparatus, and
request, in a case where the first data is not yet copied, the first processor to transfer the first data through the third path.

4. The storage system according to claim 2, wherein
the third processor is configured to
control, in a case where abnormalities are detected in the third path, the second processor to stop use of the second path.

5. The storage system according to claim 2, wherein
the second processor is configured to
receive a request for a write access to write second data to the virtual storage area from the superordinate apparatus through the second path,
determine whether third data stored in the second storage area at an address where the second data is to be written is already synchronized with data stored in the first storage area,
write, in a case where the third data is already synchronized, the second data to the second storage area and transfer the second data to the first processor through the third path,
transfer, in a case where the third data is not yet synchronized, the second data to the first processor through the third path without writing the second data to the second storage area, and
respond to the superordinate apparatus after the second data is transferred to the first processor.

6. A storage control apparatus, comprising:
a storage device configured to
store therein first management information in which common apparatus information, common area information, and first area information are associated with each other, the common apparatus information identifying a virtual apparatus and being allocated to the storage control apparatus and a first storage control apparatus, the common area information identifying a virtual storage area and being allocated to a first storage area and a second storage area, the first area information identifying the first storage area; and
a processor configured to
receive the common apparatus information and the common area information from a management apparatus,
store the common apparatus information and the common area information in the storage device in association with the first area information,
notify the common apparatus information and the common area information to a superordinate apparatus through a first path,
receive a request for a write access to write first data to the virtual storage area from the superordinate apparatus through the first path,
write the first data to the first storage area on basis of the first management information, and
transfer the first data to the first storage control apparatus through a third path to copy the first data to the second storage area.

7. A storage control method, comprising:
allocating, by a management apparatus, common apparatus information to a first storage control apparatus and a second storage control apparatus;
allocating, by the management apparatus, common area information to a first storage area and a second storage area;
notifying, by the management apparatus, the common apparatus information and the common area information to the first storage control apparatus and the second storage control apparatus;
receiving, by the first storage control apparatus, the common apparatus information and the common area information from the management apparatus;
storing by the first storage control apparatus, in a first storage device, first management information in which the common apparatus information, the common area information, and first area information are associated with each other, the first area information identifying the first storage area;
notifying, by the first storage control apparatus, the common apparatus information and the common area information to a superordinate apparatus through a first path;
receiving, by the first storage control apparatus, a request for a first access to access a virtual storage area identified by the common area information from the superordinate apparatus through the first path;
performing, by the first storage control apparatus, the first access to the first storage area on basis of the first management information;
receiving, by the second storage control apparatus, the common apparatus information and the common area information from the management apparatus;
storing by the second storage control apparatus, in a second storage device, second management information in which the common apparatus information, the common area information, and second area information are associated with each other, the second area information identifying the second storage area;
notifying, by the second storage control apparatus, the common apparatus information and the common area information to the superordinate apparatus through a second path;
receiving, by the second storage control apparatus, a request for a second access to access the virtual storage area from the superordinate apparatus through the second path; and
performing, by the second storage control apparatus, the second access to the second storage area on basis of the second management information.
